(19) United States
(12) Patent Application Publication
(10) Pub. No.: US 2024/0310994 A1
(43) Pub. Date: Sep. 19, 2024

(54) METHOD AND APPARATUS FOR TRANSFERRING VIRTUAL ITEM, ELECTRONIC DEVICE, AND STORAGE MEDIUM

(71) Applicant: Tencent Technology (Shenzhen) Company Limited, Shenzhen (CN)

(72) Inventors: Weixiang YU, Shenzhen (CN); Yun YANG, Shenzhen (CN)

(21) Appl. No.: 18/674,637

(22) Filed: May 24, 2024

Related U.S. Application Data
(63) Continuation of application No. PCT/CN2023/096883, filed on May 29, 2023.

(30) Foreign Application Priority Data
Aug. 5, 2022 (CN) 202210944071.1

(51) Int. Cl. G06F 3/0486; A63F 13/85; G06F 3/04817; G06F 3/0482

(52) U.S. Cl. CPC G06F 3/0486; A63F 13/85; G06F 3/04817; G06F 3/0482

(57) ABSTRACT

This application discloses a method for transferring a virtual item performed by an electronic device. The method includes: displaying a first storage space and a second storage space; detecting a first drag operation of dragging a target virtual item from the first storage space to the second storage space; determining a release position of a first drag operation in response to the first drag operation; transferring a target virtual item from the first storage space to a first item storage area when the release position is located in the first item storage area; and transferring at least one first-type virtual item in the first storage space to the first item storage area when the release position is on a target storage container label.

### CROSS-REFERENCE TO RELATED APPLICATIONS

This application is a continuation application of PCT Patent Application No. PCT/CN2023/096883, entitled “METHOD AND APPARATUS FOR TRANSFERRING VIRTUAL ITEM, ELECTRONIC DEVICE, AND STORAGE MEDIUM” filed on May 29, 2023, which claims priority to Chinese Patent Application No. 202210944071.1, entitled “METHOD AND APPARATUS FOR TRANSFERRING VIRTUAL ITEM, ELECTRONIC DEVICE, AND STORAGE MEDIUM” filed on Aug. 5, 2022, both of which are incorporated herein by reference in their entirety.

### FIELD OF THE TECHNOLOGY

This application relates to the field of computer technologies, and in particular, to a method and apparatus for transferring a virtual item, an electronic device, and a storage medium.

### BACKGROUND OF THE DISCLOSURE

With development of computer technologies, there are more and more types of games that can be played on a terminal. A game of a survival and construction type is relatively popular. In the game of the survival and construction type, survival and construction are used as a game theme and a gameplay of the game, a player in a game scene can control a virtual object to collect a variety of virtual items as survival supplies, and construct a territory of the virtual object.

### SUMMARY

Embodiments of this application provide a method and apparatus for transferring a virtual item, an electronic device, and a storage medium, which can reduce operation cumbersomeness of batch item transfer and improve human-computer interaction efficiency. The technical solutions are as follows:

According to an aspect, a method for transferring a virtual item is performed by an electronic device, the method including:
displaying a first storage space and a second storage space, the first storage space including multiple virtual items, the second storage space including multiple storage container labels, and each storage container label corresponding to one item storage area;
detecting a first drag operation of dragging a target virtual item from the first storage space to the second storage space;
in response to the first drag operation, determining a release position of a first drag operation;
when the release position is located in a first item storage area, transferring the target virtual item from the first storage space to the first item storage area, the first item storage area being an item storage area corresponding to a target storage container label in the multiple storage container labels; and
when the release position is on the target storage container label, transferring at least one first-type virtual item in the first storage space to the first item storage area, the first-type virtual item being a virtual item having a same type as the target virtual item.

According to an aspect, an electronic device includes one or more processors and one or more memories. The one or more memories store at least one computer program, and the at least one computer program, when executed by the one or more processors, cause the electronic device to implement the foregoing method for transferring a virtual item.

According to an aspect, a non-transitory computer-readable storage medium stores at least one computer program, and the at least one computer program, when executed by a processor of an electronic device, causes the electronic device to implement the foregoing method for transferring a virtual item.

Details of one or more embodiments of this application are provided in the accompanying drawings and descriptions below. Other features, objectives, and advantages of this application become apparent from the specification, the accompanying drawings, and the claims.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art can still derive other drawings from these accompanying drawings without creative efforts.

FIG. 1 is a schematic diagram of an implementation environment of a method for transferring a virtual item according to an embodiment of this application.

FIG. 2 is a flowchart of a method for transferring a virtual item according to an embodiment of this application.

FIG. 3 is a flowchart of a method for transferring a virtual item according to an embodiment of this application.

FIG. 4 is a schematic diagram of a display interface of a storage space according to an embodiment of this application.

FIG. 5 is a schematic principle diagram of a drag operation according to an embodiment of this application.

FIG. 6 is a schematic interface diagram of an item transfer result according to an embodiment of this application.

FIG. 7 is a flowchart of a method for transferring a virtual item according to an embodiment of this application.

FIG. 8 is a schematic principle diagram of a drag operation according to an embodiment of this application.

FIG. 9 is a schematic interface diagram of an item retrieval result according to an embodiment of this application.

FIG. 10 is a principle flowchart of a method for transferring a virtual item according to an embodiment of this application.

FIG. 11 is a principle interface diagram of an item transfer procedure according to an embodiment of this application.

FIG. 12 is a schematic structural diagram of an apparatus for transferring a virtual item according to an embodiment of this application.

FIG. 13 is a schematic structural diagram of a terminal according to an embodiment of this application.

FIG. 14 is a schematic structural diagram of an electronic device according to an embodiment of this application.

### DESCRIPTION OF EMBODIMENTS

The following describes the terms involved in this application.

Virtual scene: is a virtual environment that an application program displays (or provides) when running on a terminal. The virtual scene may be a simulated environment for a real world, may be a semi-simulated semi-virtual environment, or may be a pure virtual environment. The virtual scene may be any one of a two-dimensional virtual scene, a 2.5-dimensional virtual scene, or a three-dimensional virtual scene. A dimension of the virtual scene is not limited in the embodiments of this application. For example, the virtual scene may include a sky, a land, a sea, and the like. The land may include environment elements such as a desert and a city, and a user may control a virtual object to move in the virtual scene. In some embodiments, the virtual scene may be further configured for virtual scene confrontation between at least two virtual objects, and in the virtual scene, there is a virtual resource that can be used by the at least two virtual objects.

Virtual object: is a movable object in a virtual scene. The movable object may be a virtual person, a virtual animal, an animated person, or the like, for example, a person, an animal, a plant, a bucket, a wall, a stone, and the like that are displayed in the virtual scene. The virtual object may be a virtual image that is in the virtual scene and that is configured for representing a user. The virtual scene may include multiple virtual objects, and each virtual object has a shape and a size in the virtual scene, and occupies some space in the virtual scene. In some embodiments, when the virtual scene is a three-dimensional virtual scene, in some embodiments, the virtual object may be a three-dimensional model. The three-dimensional model may be a three-dimensional role constructed based on a three-dimensional human bone technology. The same virtual object may display different external images by wearing different skin. In some embodiments, the virtual object may alternatively be implemented by using a 2.5-dimensional or two-dimensional model, which is not limited in the embodiments of this application.

In some embodiments, the virtual object may be a player role controlled by an operation on a client, may be a non-player character (NPC) that can interact as disposed in the virtual scene, a neutral virtual object (such as a wild monster that can provide a buff, an experience value, or a virtual treasure box), or may be a game robot (such as a companion robot) disposed in the virtual scene. For example, the virtual object is a virtual person that competes in the virtual scene. In some embodiments, a quantity of virtual objects that participate in interaction in the virtual scene may be preset, or may be dynamically determined according to a quantity of clients that join the interaction.

Virtual item: is an item for which a virtual object in a virtual scene can perform interaction behavior. The virtual item may be a virtual material, a virtual prop, a virtual plant, a virtual animal, a virtual clothing, or the like, for example, seeds, food materials, tables, chairs, bricks, and the like displayed in a virtual scene. The virtual scene may include a large quantity of virtual items. Each virtual item has a shape and a size in the virtual scene, and occupies a part of space in the virtual scene. In some embodiments, when the virtual scene is a three-dimensional virtual scene, in some embodiments, the virtual item may be a three-dimensional model. In some embodiments, the virtual item may alternatively be implemented by using a 2.5-dimensional or two-dimensional model, which is not limited in the embodiments of this application.

Survival and construction game: is a game in which survival and construction are used as a game theme and a gameplay. In a game scene, a player can collect various virtual items as survival materials, establish a territory of the player, and also support using a collected raw material to synthesize a living item of the player. The survival and construction game has a wide variety of gameplays and a high degree of freedom. A player can freely explore a game scene, and may further use any item in the game scene to construct, create, or assemble a new item required for survival. For example, according to different settings of a background of a game, a survival and construction game includes: a space survival and construction game and a sandbox survival and construction game.

In a current survival and construction game, due to needs of survival and construction, a player often needs to control a virtual object to collect a large quantity of virtual items in a virtual scene. Generally, the virtual item is preferentially placed in a backpack of the virtual object. Due to a limited capacity of the backpack, when the backpack is full, the player needs to transfer the virtual item in the backpack to a cabinet, so as to collect a new virtual item.

In the foregoing process of transferring the virtual item from the backpack to the cabinet, the player often needs to manually transfer a large quantity of virtual items in the backpack to the cabinet frequently, and the player further needs to manually classify the items transferred to the cabinet. For example, during item transfer, the player needs to open a cabinet interface, select a virtual item to be transferred in the backpack, drag the selected virtual item from the backpack to an item storage area of a locker in the cabinet, and then release the hand to implement transfer of the single item; and repeat the above drag operations for many times until all the similar items are transferred to the cabinet, and then tap a cabinet setting button to open a pop-up window to rename the cabinet or select a cabinet icon. It can be learned that the foregoing batch item transfer operations are cumbersome, and an operation link is relatively long. Therefore, the item transfer efficiency is low, the man-computer interaction efficiency is low, and user experience is poor.

In view of this, an embodiment of this application provides a method for transferring a virtual item, to provide an interactive manner of rapidly transferring the same type of item from one storage space to another storage space for a frequent requirement that a player performs batch item transfer in a survival and construction game. For example, items of the same type can be transferred in batches from a backpack to a cabinet in one tap, or items of the same type can be retrieved in batches from the cabinet to the backpack in one tap, so as to implement rapid batch item transfer, thereby improving item transfer efficiency and man-computer interaction efficiency, and improving user experience.

The following describes a system architecture in an embodiment of this application.

FIG. 1 is a schematic diagram of an implementation environment of a method for transferring a virtual item according to an embodiment of this application. Referring to FIG. 1, the implementation environment includes: a first terminal 120, a server 140, and a second terminal 160.

The first terminal 120 is installed with and runs an application program that supports a virtual scene. In some embodiments, the application program includes: any one of a survival and construction game, an open world game, an operation and construction game, an exploration game, a sandbox game, a first-person shooting (FPS) game, a third-person shooting (TPS) game, a multiplayer online battle arena (MOBA) game, a virtual reality application program, a three-dimensional map program, or a multi-person device survival game.

In some embodiments, the first terminal 120 is a terminal used by a first user. When the first terminal 120 runs the application program, a user interface of the application program is displayed on a screen of the first terminal 120, and a virtual scene is loaded and displayed in the application program based on an opening operation performed by the first user in the user interface. The first user operates a first virtual object in the virtual scene by using the first terminal 120 to perform an activity. The activity includes but is not limited to: at least one of adjusting a body posture, crawling, walking, running, riding, jumping, driving, picking, shooting, attacking, throwing, and combating. For example, the first virtual object may be a virtual person, such as a simulated person role or an animated person role. The first terminal 120 can control the first virtual object to pick up or collect a virtual item in the virtual scene.

The first terminal 120 and the second terminal 160 communicate directly or indirectly with the server 140 by using a wireless network or a wired network.

The server 140 includes at least one of one server, multiple servers, a cloud computing platform, or a virtualization center. The server 140 is configured to provide a background service for an application program that supports a virtual scene. In some embodiments, the server 140 undertakes primary computing work, and the first terminal 120 and the second terminal 160 undertake secondary computing work. Alternatively, the server 140 undertakes secondary computing work, and the first terminal 120 and the second terminal 160 undertake primary computing work. Alternatively, coordinated computing is performed among the server 140, the first terminal 120, and the second terminal 160 by using a distributed computing architecture.

In some embodiments, the server 140 is an independent physical server, or a server cluster or a distributed system formed by multiple physical servers, or a cloud server that provides basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

The second terminal 160 is installed with and runs an application program that supports a virtual scene. In some embodiments, the application program includes: any one of a survival and construction game, an open world game, an operation and construction game, an exploration game, a sandbox game, an FPS game, a TPS game, a MOBA game, a virtual reality application program, a three-dimensional map program, or a multi-person device survival game.

In some embodiments, the second terminal 160 is a terminal used by a second user. When the second terminal 160 runs the application program, a user interface of the application program is displayed on a screen of the second terminal 160, and a virtual scene is loaded and displayed in the application program based on an opening operation performed by the second user in the user interface. The second user operates a second virtual object in the virtual scene by using the second terminal 160 to perform an activity. The activity includes but is not limited to: at least one of adjusting a body posture, crawling, walking, running, riding, jumping, driving, picking, shooting, attacking, throwing, and combating. For example, the second virtual object may be another virtual person that is different from the first virtual object, such as a simulated person role or an animated person role. The second terminal 160 can control the second virtual object to pick up or collect a virtual item in the virtual scene.

In some embodiments, the first virtual object controlled by the first terminal 120 and the second virtual object controlled by the second terminal 160 are in the same virtual scene. In this case, the first virtual object can interact with the second virtual object in the virtual scene.

In some embodiments, the first virtual object and the second virtual object are in an adversarial relationship. For example, the first virtual object and the second virtual object belong to different camps or teams. Alternatively, the first virtual object and the second virtual object are in a teammate relationship. For example, the first virtual object and the second virtual object belong to the same camp, the same team, have a buddy relationship, or have a temporary communication permission.

In some embodiments, the first terminal 120 or the second terminal 160 displays a first storage space and a second storage space, the second storage space displays multiple storage container labels, and each storage container label corresponds to one item storage area. According to the method for transferring a virtual item in this embodiment of this application, when a drag operation for dragging a target virtual item from the first storage space to the second storage space is detected, a release position of the drag operation is determined. If the release position is located in an item storage area corresponding to a target storage container label, the target virtual item is directly transferred from the first storage space to the item storage area corresponding to the target storage container label. If the release position is located on the target storage container label, all virtual items of the same type as the target virtual item are batch transferred to the item storage area corresponding to the target storage container label. For example, the first storage space is a carry-on storage space of a virtual object, such as a backpack or a luggage. The second storage space is a non-carry-on storage space of a virtual object, such as a cabinet, a warehouse, a house, a courtyard, and a base. In this way, batch transfer of virtual items and the same type of items through one tap can be implemented, thereby greatly improving item transfer efficiency and man-computer interaction efficiency.

In some embodiments, the application programs installed on the first terminal 120 and the second terminal 160 are the same, or the application programs installed on the two terminals are the same type of application programs on different operating system platforms. Both the first terminal 120 and the second terminal 160 refer to one of multiple terminals. In this embodiment of this application, the first terminal 120 and the second terminal 160 are merely used as examples for description.

Device types of the first terminal 120 and the second terminal 160 are the same or different. The device types include: at least one of a smartphone, a tablet computer, a smart sound box, a smart watch, a smart handheld console, a portable game device, an in-vehicle terminal, a laptop portable computer, or a desktop computer, and is not limited thereto. For example, both the first terminal 120 and the second terminal 160 are smartphones or other portable game devices. The following embodiments are described by using an example in which a terminal includes a smartphone.

A person skilled in the art can learn that a quantity of the foregoing terminals is more or less. For example, the foregoing terminal is only one, or the foregoing terminal is dozens or hundreds, or more. A quantity of terminals and a device type are not limited in the embodiments of this application.

The following briefly describes a batch item transfer procedure in the embodiments of this application.

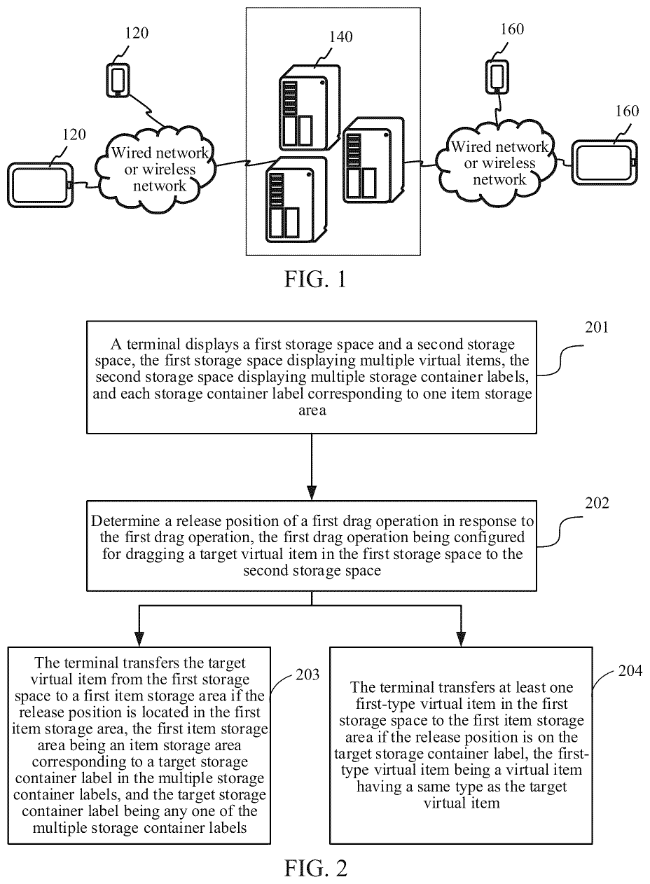

FIG. 2 is a flowchart of a method for transferring a virtual item according to an embodiment of this application. Referring to FIG. 2, this embodiment is performed by an electronic device. The following uses an example in which the electronic device is a terminal for description. This embodiment includes the following operations:

201. The terminal displays a first storage space and a second storage space, the first storage space displaying multiple virtual items, the second storage space displaying multiple storage container labels, and each storage container label corresponding to one item storage area.

The terminal in this embodiment of this application refers to any electronic device that is used by a user and that supports transfer of a virtual item between different storage spaces. The terminal is installed with and runs an application program that supports a virtual scene. In some embodiments, the application program includes: a survival and construction game, an open world game, an operation and construction game, an exploration game, a sandbox game, an FPS game, a TPS game, a MOBA game, a virtual reality application program, a three-dimensional map program, a multi-person device survival game, or the like.

The virtual item in this embodiment of this application refers to an item that can be collected and stored in a storage space by a virtual object in a virtual scene. In some embodiments, the virtual item includes: a virtual material, a virtual prop, a virtual plant, a virtual animal, a virtual clothing, or the like.

The storage space in this embodiment of this application refers to a virtual space that can temporarily or permanently store a virtual item. For example, the storage space may be divided into a carry-on storage space and a non-carry-on storage space. The carry-on storage space is a storage space that can be moved along with an action of a virtual object, such as a backpack, a luggage, a package, and a material package of the virtual object. The non-carry-on storage space refers to a storage space that cannot be moved along with an action of a virtual object, such as a cabinet, a safe box, a warehouse, a house, a courtyard, and a base of the virtual object.

In some embodiments, the virtual object may be bound to a storage space, and a related operation permission of the storage space is only open to the bound virtual object. For example, the operation permission includes: an item storage permission, an item removal permission, an item use permission, and an item discarding permission. In this way, safety of a virtual item stored in a storage space can be ensured, and a virtual item owned by a virtual object cannot be lost.

For example, the first storage space and the second storage space in this embodiment of this application refer to two different storage spaces bound to the same virtual object. For example, the first storage space is a carry-on storage space A, and the second storage space is a non-carry-on storage space B. For another example, the first storage space is a carry-on storage space A1, and the second storage space is a carry-on storage space A2. For another example, the first storage space is a non-carry-on storage space B1, and the second storage space is a non-carry-on storage space B2. This is not specifically limited in this embodiment of this application.

In some embodiments, a user starts a game application on a terminal, loads and displays a virtual scene by using the game application, and can control a virtual object to collect or pick up a virtual item in the virtual scene. When the user needs to transfer a virtual item from one storage space to another storage space, the user may open a first storage space in which a to-be-transferred virtual item is stored, and then open a second storage space to which the virtual item is to be transferred, so that the terminal displays the first storage space and the second storage space. In this embodiment of this application, an example in which the first storage space is a carry-on storage space, and the second storage space is a storage space that is different from the first storage space is configured for description. That is, the second storage space may be a carry-on or non-carry-on storage space.

In some embodiments, the user opens the first storage space by using a user interface (UI) control of the first storage space. For example, when the first storage space is a backpack of a virtual object, the UI control of the first storage space refers to a backpack control. Similarly, the user opens the second storage space by using a UI control of the second storage space. For example, when the second storage space is a cabinet of the virtual object, the UI control of the second storage space refers to a cabinet control. In some embodiments, when the user needs to transfer a virtual item from the backpack to the cabinet, the user may successively open the backpack interface by using the backpack control, and open the cabinet interface by using the cabinet control, so that the terminal displays both the backpack interface (that is, the first storage space) and the cabinet interface (that is, the second storage space).

In some other embodiments, the user enters an item transfer interface by using an item management control. The item management control may be a UI control directly displayed in a virtual scene. Alternatively, the item management control is an interaction option that is expanded and displayed after the user taps a menu control in a virtual scene. Alternatively, the item management control is a setting option displayed after the user enters the backpack interface by using the backpack control. The item management control is not specifically limited in this embodiment of this application. The item transfer interface displayed in the game application includes the first storage space and the second storage space that are bound to the virtual object.

In some embodiments, multiple virtual items to be transferred are displayed in the first storage space. The multiple virtual items are all stored in the first storage space. The multiple virtual items may include virtual items of one or more different types. For example, the multiple virtual items include: 10 services of straw cotton (each containing 20 pieces of straw cotton), 6 services of ores (each containing 20 ores), 4 services of crabs (each containing 20 crabs), and the like. This embodiment of this application sets no specific limitation on a type of an item included in the multiple virtual items.

In some embodiments, multiple storage container labels are displayed in the second storage space, and each storage container label corresponds to one item storage area. For example, the multiple storage container labels are displayed in a storage container list manner in the second storage space, or the multiple storage container labels are displayed in a tile or another layout manner in the second storage space. A display manner of the storage container labels is not specifically limited in this embodiment of this application. Each storage container label is corresponding to one storage container in the second storage space, and each storage container has its item storage area. For example, when the second storage space is a “cabinet”, a storage container label “locker 1” corresponds to the first locker in the cabinet, and a storage space of the first locker is an item storage area corresponding to the storage container label.

In some embodiments, each storage container label displayed in the second storage space is an interactive UI control. When the user selects any storage container label, a UI control corresponding to the storage container label is set to a selected state, so that an item storage area corresponding to the selected storage container label is displayed in the second storage space. In the foregoing manner, the user can view, at any time, which virtual items are stored in an item storage area corresponding to a selected storage container label, thereby improving management efficiency of the virtual item.

202. The terminal determines a release position of a first drag operation in response to the first drag operation, the first drag operation being configured for dragging a target virtual item in the first storage space to the second storage space.

When detecting an operation of dragging the target virtual item in the first storage space to the second storage space, the terminal confirms that the first drag operation is detected.

In some embodiments, for a target virtual item in multiple virtual items stored in the first storage space, when the user performs a drag operation of dragging the target virtual item to the second storage space, the terminal determines a release position of the drag operation in response to the drag operation of dragging the target virtual item to the second storage space. For case of description, dragging the target virtual item in the first storage space to the second storage space is referred to as a first drag operation. For the target virtual item in the first storage space, when the user performs the first drag operation, the terminal determines a release position of the first drag operation. The release position refers to a position after the user drags the target virtual item to the second storage space and releases the hand, that is, an operation end point corresponding to a drag track of the drag operation. The target virtual item is any virtual item in the first storage space.

In some embodiments, the second storage space includes an area for displaying a storage container label, and also includes an item storage area corresponding to the storage container label. If the release position is located in an item storage area corresponding to a target storage container label, the following operation 203 is performed. If the release position is located on the target storage container label, the following operation 204 is performed. The target storage container label may be any storage container label in multiple storage container labels displayed in the second storage space. This is not specifically limited in this embodiment of this application.

203. The terminal transfers the target virtual item from the first storage space to a first item storage area if the release position is located in the first item storage area, the first item storage area being an item storage area corresponding to a target storage container label in the multiple storage container labels, and the target storage container label being any one of the multiple storage container labels.

In some embodiments, if the terminal detects that the release position determined in operation 202 is located in the first item storage area, that is, the item storage area corresponding to the target storage container label in the second storage space, the user drags the target virtual item from the first storage space to the item storage area displayed in the second storage space. In this case, a transfer operation on a single virtual item is triggered, that is, the terminal determines a target virtual item selected from a start position of the first drag operation, and then determines the first item storage area in which the release position of the first drag operation is located, so as to transfer the target virtual item from the first storage space to the first item storage area in the second storage space. The target virtual item is any virtual item stored in the first storage space selected from the start position of the first drag operation, and the target storage container label is a storage container label corresponding to an item storage area in which the release position of the drag operation is located.

In operation 203, an interaction manner in which an item transfer operation is performed only on the selected target virtual item is provided. One service of target virtual items selected by the drag operation may include one or more target virtual items because the target virtual items may be merged/stacked when stored in the first storage space to combine the multiple target virtual items into one service of target virtual items for management and storage to save storage resources in the first storage space. For example, one service of straw cotton displayed in the first storage space includes 20 pieces of straw cotton. In this case, when the user performs an item transfer operation, one service of virtual item is used as an operating unit. That is, transferring one service of straw cotton at a time is equivalent to transferring 20 pieces of straw cotton contained in one service of straw cotton at a time.

Although one service of target virtual item may include one or more target virtual items, in response to a drag operation, the terminal performs item transfer only on the target virtual item selected by the drag operation. If the target virtual item selected by the drag operation includes only a single target virtual item, the single target virtual item will be transferred at a time. If the target virtual item selected by the drag operation includes multiple target virtual items, the multiple target virtual items will be transferred at a time. However, the terminal does not perform a transfer operation on an item other than the target virtual item selected by the current drag operation.

204. The terminal transfers at least one first-type virtual item in the first storage space to the first item storage area if the release position is on the target storage container label, the first-type virtual item being a virtual item having a same type as the target virtual item.

In some embodiments, if the terminal detects that the release position determined in operation 202 is located on the target storage container label in the second storage space (not the item storage area), the terminal drags the target virtual item from the first storage space onto the target storage container label displayed in the second storage space. In this case, a batch transfer operation is triggered on all virtual items of the same type. That is, the terminal determines a target virtual item selected from a start position of the drag operation, determines a target storage container label on which the release position of the drag operation is located, then determines all virtual items of the same type as the target virtual item from the first storage space, and finally transfers all the virtual items of the same type from the first storage space to the item storage area corresponding to the target storage container label in the second storage space. The target virtual item is any virtual item stored in the first storage space selected at the start position of the drag operation, and the target storage container label is a storage container label in which the release position of the drag operation is located. In some embodiments, all the virtual items of the same type as the target virtual item include: the target virtual item itself and virtual items of the same type as the target virtual item in the first storage space.

In some embodiments, when the user drags the target virtual item displayed in the first storage space onto the target storage container label displayed in the second storage space, and then releases the hand (that is, the finger leaves the terminal screen), the terminal detects the first drag operation, that is, a drag operation of dragging the target virtual item in the first storage space to the second storage space, and the release position of the first drag operation is located on the target storage container label of the second storage space. In this case, the terminal determines the target virtual item associated with the start position of the drag operation (representing a target virtual item selected in the current drag operation), and determines at least one first-type virtual item from multiple virtual items stored in the first storage space, that is, all virtual items of the same type as the target virtual item. For example, the terminal determines an item type of the target virtual item, and obtains all virtual items of the item type from the multiple virtual items stored in the first storage space. All the virtual items include: the target virtual item itself and virtual items of the same type as the target virtual item in the first storage space. Then, the terminal batch transfers, in the first storage space, all the virtual items of the same type as the target virtual item to the item storage area corresponding to the target storage container label.

In some embodiments, the start position of the drag operation refers to a start point of a drag track of the drag operation, and the virtual item associated with the start position refers to a display area in which the start position is located. Generally, each virtual item in the first storage space has one display area, and the virtual item associated with the start position may be determined according to a display area of which virtual item in which the start position is located.

In some embodiments, after determining that the drag operation is completed on the selected target virtual item, the terminal uses an item identifier of the target virtual item as an item type of the target virtual item. For example, if the target virtual item selected by the drag operation is “straw cotton”, an item identifier 031 of “straw cotton” is used as the item type of the target virtual item. In some embodiments, after determining that the drag operation is completed on the selected target virtual item, the terminal may further use a type identifier associated with the target virtual item selected by the drag operation as an item type of the target virtual item. For example, if the virtual item selected by the drag operation is “straw cotton”, after determining that a type identifier 001 associated with “straw cotton” (for example, the type identifier 001 represents “crop”), the type identifier 001 is used as the item type of the target virtual item. A manner of obtaining the item type is not specifically limited in this embodiment of this application.

In the foregoing process, when the terminal detects that a drag operation is performed and a release position of the drag operation is located on a storage container label (not an item storage area) displayed in the second storage space, the user has a batch item transfer requirement for the selected virtual item and items of the same type. Further, the terminal determines the target virtual item selected by the drag operation, and obtains, from the multiple virtual items stored in the first storage space according to the item type of the target virtual item, all virtual items of the same type as the target virtual item. All the virtual items of the same type as the target virtual item include: the target virtual item itself and virtual items of the same type as the target virtual item in the first storage space. In other words, virtual items of the same type are other virtual items that are not selected by the drag operation in the first storage space and that have the same item type as the target virtual item, and the virtual items of the same type may be referred to as items of the same type. Then, the terminal automatically batch transfers all the virtual items of the same type as the target virtual item from the first storage space to the item storage area corresponding to the target storage container label in the second storage space.

The target virtual item refers to one service of virtual item selected by the drag operation, and one service of virtual item may include one or more target virtual items. For example, the drag operation selects one service of straw cotton, and one service of straw cotton contains 20 pieces of straw cotton. Similarly, the virtual items of the same type refer to one or more services of virtual items that are not selected by the drag operation but have the same item type as the target virtual item. In other words, the virtual items of the same type may be one or more services, and each service of virtual items of the same type may include one or more virtual items of the same type. For example, the drag operation selects one service of straw cotton, and a total of eight services of straw cotton are stored in the first storage space. In addition to the one service of straw cotton selected by the drag operation, seven services of straw cotton of the same type may be obtained, and each of the seven services of straw cotton includes 20 pieces of straw cotton. Finally, all virtual items of the same type as the target virtual item “straw cotton” that are obtained by the terminal include: one service of target virtual item (one service of straw cotton selected by the drag operation) and seven services of virtual items of the same type (seven services of straw cotton of the same type in the first storage space). In total, eight services of straw cotton, that is, 160 pieces of straw cotton need to be transferred from the first storage space to the item storage area corresponding to the target storage container label.

In some embodiments, in the item transfer process, the terminal removes all virtual items of the same type as the target virtual item from the first storage space, and displays the virtual items in the item storage area corresponding to the target storage container label in the second storage space, so as to implement batch item transfer of all the virtual items of the same type as the target virtual item, and presents visual display to the user after the item transfer is complete.

In some embodiments, in the item transfer process, the terminal sends a batch item transfer request to the server. The batch item transfer request carries item numbers of all the virtual items of the same type as the target virtual item. The item number is configured for representing a specific number of the virtual item, and the item identifier is configured for representing a type of the virtual item. Item numbers of different virtual items are different and are unique, and item identifiers of virtual items of the same type are the same. For example, an item identifier of a virtual item is 031, which represents that the virtual item is “straw cotton”, but an item number of the virtual item is 000010, which represents that the virtual item is the tenth virtual item collected by a virtual object.

In some embodiments, the terminal stores item numbers of all the virtual items of the same type as the target virtual item into an item number queue, and encapsulates the item number queue into the batch item transfer request. In response to the batch item transfer request, the server obtains the item number queue by means of parsing. The server removes each item number in the item number queue from storage metadata in the first storage space, and adds each item number to storage metadata associated with the target storage container label in the second storage space, thereby implementing batch transfer and storage of all virtual items indicated by the item numbers.

In some other embodiments, after determining the target virtual item selected by the drag operation, the terminal encapsulates the item number and the item type of the target virtual item into the batch item transfer request, and sends the batch item transfer request to the server. In response to the batch item transfer request, the server obtains the item number and the item type of the target virtual item by means of parsing. Then, the server queries the storage metadata of the first storage space, so as to determine item numbers of all the virtual items that are stored in the first storage space and that are of the same type as the target virtual item. The server deletes, from the storage metadata of the first storage space, the item numbers of all the virtual items of the same type as the target virtual item in the request. Then, the server adds, to the storage metadata associated with the target storage container label of the second storage space, the item numbers of all the virtual items of the same type as the target virtual item, so as to implement batch transfer and storage of all the virtual items of the same type as the target virtual item.

All the foregoing technical solutions can be randomly combined to form exemplary embodiments of the present disclosure, and details are not described herein.

According to the method provided in this embodiment of this application, when a drag operation from one storage space to another storage space is detected, based on different release positions of the drag operation, a single transfer operation for a currently selected virtual item and a batch transfer operation for all virtual items of the same type are separately provided, that is, when the release position is located in an item storage area, only the currently selected virtual item is transferred; when the release position is located on a storage container label, all the virtual items of the same type are transferred in batches, so that a user can control the release position of the drag operation, to flexibly control which virtual items need to be transferred in batches currently. In addition, batch transfer of items of the same type can be controlled by using only one drag operation. This prevents the user from manually repeatedly performing an item transfer operation for multiple times, thereby reducing operation cumbersomeness of the user, and improving item transfer efficiency and human-computer interaction efficiency.

The following describes in detail a batch item transfer procedure in an embodiment of this application.

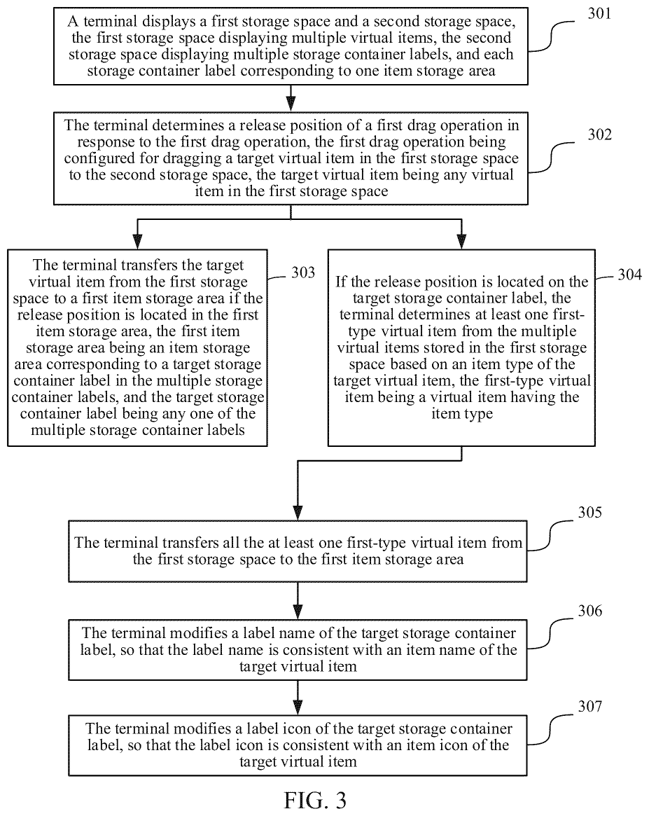

FIG. 3 is a flowchart of a method for transferring a virtual item according to an embodiment of this application. Referring to FIG. 3, this embodiment is performed by an electronic device. The following uses an example in which the electronic device is a terminal for description. This embodiment includes the following operations:

301. The terminal displays a first storage space and a second storage space, the first storage space displaying multiple virtual items, the second storage space displaying multiple storage container labels, and each storage container label corresponding to one item storage area.

Multiple storage container labels are displayed in the second storage space, and each storage container label corresponds to one item storage area. For example, the multiple storage container labels are displayed in a storage container list manner in the second storage space, or the multiple storage container labels are displayed in a tile or another layout manner in the second storage space. A display manner of the storage container labels is not specifically limited in this embodiment of this application. Each storage container label is corresponding to one storage container in the second storage space, and each storage container has its item storage area. For example, when the second storage space is a “cabinet”, a storage container label “locker 1” corresponds to the first locker in the cabinet, and a storage space of the first locker is an item storage area corresponding to the storage container label.

In some embodiments, each storage container label displayed in the second storage space is an interactive user interface (UI) control. When the user selects any storage container label, a UI control corresponding to the storage container label is set to a selected state, so that an item storage area corresponding to the selected storage container label is displayed in the second storage space. In the foregoing manner, the user can view, at any time, which virtual items are stored in an item storage area corresponding to a selected storage container label, thereby improving management efficiency of the virtual item.

In some embodiments, a user starts a game application on a terminal, loads and displays a virtual scene by using the game application, and can control a virtual object to collect or pick up a virtual item in the virtual scene. When the user needs to transfer a virtual item from one storage space to another storage space, the user may open a first storage space in which a to-be-transferred virtual item is stored, and then open a second storage space to which the virtual item is to be transferred, so that the terminal displays the first storage space and the second storage space.

In this embodiment of this application, an example in which the first storage space is a carry-on storage space, and the second storage space is a storage space that is different from the first storage space is configured for description. That is, the second storage space may be a carry-on or non-carry-on storage space. For example, the first storage space is a carry-on storage space of a virtual object controlled by the terminal, such as a backpack, a luggage, a package, and a material package. The second storage space is a non-carry-on storage space such as a cabinet, a safe box, a warehouse, a house, a courtyard, and a base that do not move with the virtual object.

In some embodiments, the user opens the first storage space by using a UI control of the first storage space. For example, when the first storage space is a backpack of a virtual object, the UI control of the first storage space refers to a backpack control. Similarly, the user opens the second storage space by using a UI control of the second storage space. For example, when the second storage space is a cabinet of the virtual object, the UI control of the second storage space refers to a cabinet control. In some embodiments, when the user needs to transfer a virtual item from the backpack to the cabinet, the user may successively open the backpack interface by using the backpack control, and open the cabinet interface by using the cabinet control, so that the terminal displays both the backpack interface (that is, the first storage space) and the cabinet interface (that is, the second storage space).

In some other embodiments, the user enters an item transfer interface by using an item management control, and the item management control may be a UI control directly displayed in a virtual scene. Alternatively, the item management control is an interaction option that is expanded and displayed after the user taps a menu control in a virtual scene. Alternatively, the item management control is a setting option displayed after the user enters the backpack interface by using the backpack control. The item management control is not specifically limited in this embodiment of this application. The item transfer interface displayed in the game application includes the first storage space and the second storage space that are bound to the virtual object.

In some embodiments, multiple virtual items to be transferred are displayed in the first storage space. The multiple virtual items are all stored in the first storage space. The multiple virtual items may include virtual items of one or more different types. For example, the multiple virtual items include: 10 services of straw cotton (each containing 20 pieces of straw cotton), 6 services of ores (each containing 20 ores), 4 services of crabs (each containing 20 crabs), and the like. This embodiment of this application sets no specific limitation on an item type included in the multiple virtual items.

In some embodiments, a storage container list is displayed in the second storage space. The storage container list includes multiple storage container labels. Each storage container label is an interactive UI control. In addition, an item storage area corresponding to a storage container label of an interactive UI control currently in a selected state is further displayed in the second storage space.

For example, when the user selects any storage container label, an interactive UI control of the storage container label is set to a selected state, so that an item storage area corresponding to the selected storage container label is displayed in the second storage space. Alternatively, when the user does not select any storage container label, an interactive UI control of the first storage container label in the storage container list is set to a selected state by default, and an item storage area corresponding to the selected storage container label is displayed in the second storage space. In the foregoing manner, the user can view, at any time, which virtual items are stored in an item storage area corresponding to a selected storage container label, thereby improving management efficiency of the virtual item.

For example, when no interactive UI control of a storage container label in the storage container list is in the selected state, only the collapsed storage container list is displayed in the second storage space, and an item storage area is not displayed. When an interactive UI control of any storage container label in the storage container list is in the selected state, the storage container label to which the interactive UI control in the selected state belongs is highlighted in the storage container list of the second storage space, and an item storage area corresponding to the storage container label is further displayed in the second storage space.

In the storage container list, only one storage container label can be selected. In this way, whenever the user selects a new storage container label, an interactive UI control of the selected new storage container label is set to the selected state, and the interactive UI control of the previously selected storage container label is automatically switched from the selected state to an unselected state. Alternatively, the storage container list may further support simultaneous selection of multiple storage container labels. In this way, whenever the user selects a new storage container label, an interactive UI control of the selected new storage container label is set to the selected state, and an interactive UI control of a storage container label that is originally in the selected state also remains unchanged, which is equivalent to that the second storage space displays item storage areas corresponding to the storage container labels to which all the interactive UI controls in the selected state respectively belong.

In some other embodiments, by default, the storage container list and an item storage area corresponding to each storage container label in the storage container list are displayed in the second storage space. That is, it is equivalent to displaying, by default, item storage areas corresponding to all storage container labels, instead of distinguishing the selected state from the unselected state of the interactive UI control of the storage container label. In the foregoing implementation, it is convenient for the user to view a virtual item currently stored in an item storage area corresponding to each storage container label, which helps to visually display a storage status of the second storage space, so that the user can formulate a batch item transfer policy, improving item management efficiency.

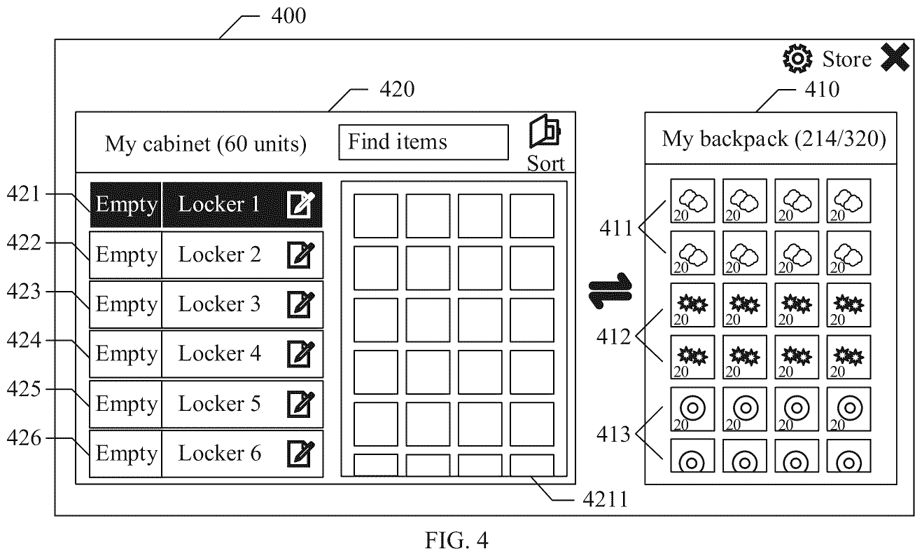

FIG. 4 is a schematic diagram of a display interface of a storage space according to an embodiment of this application. As shown in FIG. 4, in a virtual scene 400, a first storage space 410 and a second storage space 420 are displayed. The first storage space 410 includes three different types of virtual items 411-413. Six storage container labels 421-426 are displayed in the second storage space 420. Currently, interactive UI controls of the storage container labels 422-426 are in an unselected state, and an interactive UI control of the storage container label 421 is in a selected state. Therefore, an item storage area 4211 corresponding to the selected storage container label 421 is further displayed in the second storage space 420. It can be seen that because only the interactive UI control of the storage container label 421 is in the selected state, the storage container label 421 is highlighted in the second storage space 420. For example, the item storage area corresponding to the storage container label 421 is idle, that is, the item storage area corresponding to the storage container label 421 does not store any virtual item.

302. The terminal determines a release position of a first drag operation in response to the first drag operation, the first drag operation being configured for dragging a target virtual item in the first storage space to the second storage space, the target virtual item being any virtual item in the first storage space.

The target virtual item is any virtual item selected by the first drag operation. For example, the target virtual item refers to: if a start position of the drag operation is located in a display area of a virtual item in the first storage space, determining the virtual item corresponding to the start position as the target virtual item.

In some embodiments, the user's finger first touches and presses the target virtual item in the first storage space. After detecting a pressure signal applied by the finger of the user to a screen of the terminal, a touch sensor of the terminal determines a touch point associated with the pressure signal as the start position of the drag operation. Then, the terminal continuously senses, by using the touch sensor, the pressure signal applied by the finger of the user. Because the finger of the user slides dynamically, the terminal can determine a drag track of the finger of the user based on a series of touch points sensed in real time. Then, when the touch sensor does not sense the pressure signal for more than preset duration, indicating that the finger of the user leaves the screen of the terminal (that is, the drag operation stops and the drag operation ends), in this case, the terminal determines a release position of the drag track. The preset duration is any value greater than 0.

In some embodiments, after the start position and the release position of the drag track are determined in the foregoing manner, if screen coordinates of the start position are located in a display area of any virtual item in the first storage space and screen coordinates of the release position are located in the second storage space, it is determined that the first drag operation involved in operation 302 is detected, that is, the target virtual item in the first storage space is dragged to the second storage space.

In some embodiments, in response to the first drag operation, the terminal determines a virtual item associated with the start position as the target virtual item selected by the first drag operation. In addition, the terminal obtains the release position of the first drag operation, and determines an area in which the release position is located in the second storage space. In some embodiments, the virtual item associated with the start position refers to a display area in which the screen coordinates of the start position are located in the first storage space.

The second storage space includes both an area for displaying a storage container label and an item storage area corresponding to the storage container label. If the release position is located in the item storage area, the following operation 303 is performed. If the release position is located on the storage container label, the following operation 304 is performed.

303. The terminal transfers the target virtual item from the first storage space to a first item storage area if the release position is located in the first item storage area, the first item storage area being an item storage area corresponding to a target storage container label in the multiple storage container labels, and the target storage container label being any one of the multiple storage container labels.

The target storage container is any storage container label indicated by the release position of the drag operation in the second storage space. For example, when the release position is located in the item storage area, the target container label refers to a storage container label corresponding to the item storage area in which the release position is located. When the release position is on the storage container label, the target storage container label is a storage container label on which the release position is located.

An implementation of operation 303 is the same as that of operation 203 in the previous embodiment, and details are not described herein again.

304. If the release position is located on the target storage container label, the terminal determines at least one first-type virtual item from the multiple virtual items stored in the first storage space based on an item type of the target virtual item, the first-type virtual item being a virtual item having the item type.

The at least one first-type virtual item is a virtual item of the same type as the target virtual item.

In some embodiments, if the terminal detects that the release position determined in operation 302 is located on the target storage container label in the second storage space (not the item storage area), the terminal drags the target virtual item from the first storage space onto the target storage container label displayed in the second storage space. In this case, a batch transfer operation is triggered on all virtual items of the same type, that is, the terminal determines, from the first storage space, all virtual items of the same type as the target virtual item, that is, all first-type virtual items. Then, the terminal transfers all the first-type virtual items from the first storage space to the first item storage area.

In some embodiments, when the user drags the target virtual item displayed in the first storage space onto the target storage container label displayed in the second storage space, and then releases the hand (that is, the finger leaves the terminal screen), the terminal detects a drag operation of dragging the target virtual item in the first storage space to the second storage space, and a release position of the drag operation is located on the target storage container label of the second storage space. In this case, the terminal determines an item type of the target virtual item, and obtains all virtual items of the item type from the multiple virtual items stored in the first storage space. All the virtual items include: the target virtual item itself and virtual items of the same type as the target virtual item in the first storage space.

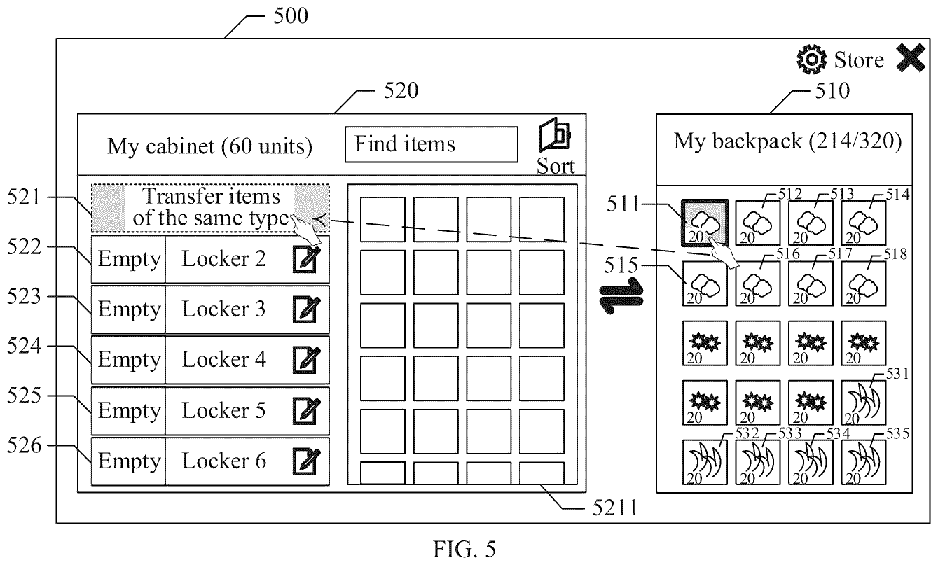

FIG. 5 is a schematic principle diagram of a drag operation according to an embodiment of this application. As shown in FIG. 5, in a virtual scene 500, a first storage space 510 and a second storage space 520 are displayed. In addition, six storage container labels 521-526 are displayed in the second storage space 520. Currently, an interactive UI control of the storage container label 521 is in a selected state. Therefore, an item storage area 5211 corresponding to the selected storage container label 521 is further displayed in the second storage space 520. Further, assuming that the user drags a virtual item 511 in the first storage space 510 at the upper left corner onto the storage container label 521 displayed in the second storage space 520 and releases the hand, the terminal determines that a drag operation of dragging the target virtual item in the first storage space to the second storage space is detected. Further, the terminal determines that the virtual item 511 is the target virtual item selected by the drag operation, and determines that the container label 521 is the target storage container label selected by the drag operation. Further, the terminal determines that the release position of the drag operation is located on the target storage container label (that is, the storage container label 521), so as to trigger all virtual items 511-518 in the first storage space 510 that are of the same type as the target virtual item (that is, the virtual item 511). In this way, the virtual items are transferred in batches to the item storage area 5211 corresponding to the target storage container label (that is, the storage container label 521) in the second storage space 520. Each service of virtual item in the virtual items 511-518 includes 20 virtual items.

In the foregoing process, a possible implementation in which the user drags a virtual item in the first storage space onto a storage container label in the second storage space, so as to start a batch item transfer procedure for all virtual items of the same type as the virtual item is shown. In this implementation, the batch item transfer procedure is triggered only when the user drags a virtual item to a storage container label by using a drag operation. The user still triggers a single item transfer procedure when dragging a virtual item to an item storage area by using a drag operation. In other words, in a single item transfer procedure, a drag operation only triggers transfer of a currently selected target virtual item (which may be one or more), but does not transfer an unselected virtual item of the same type. In the batch item transfer process, the drag operation transfers all virtual items of the same type as the target virtual item in batches. Different item transfer procedures are started by providing different trigger manners, so that the user can perform a corresponding trigger operation according to an item transfer requirement of the user, which has higher flexibility and operability.

In some embodiments, the user drags the target virtual item in the first storage space onto the target storage container label in the second storage space and releases the hand, so that the drag operation can be triggered. In some other embodiments, even if the user does not release the hand after dragging to the target storage container dragged in the second storage space, it is considered that the drag operation is detected as long as the terminal detects that the start position of the drag track is in the display area of the target virtual item in the first storage space, and that the latest touch point of the drag track (but not necessarily the release position because the user may keep the touch state continuously, that is, the user does not release the hand) is in the display area of the target storage container label in the second storage space. This embodiment of this application sets no specific limitation on whether the user needs to release the hand to trigger a drag operation.

In some other embodiments, as the user performs the operation of dragging the target virtual item, the terminal may further display that the target virtual item follows the finger of the user to move along the drag track until the target virtual item is dragged onto the target storage container label. In this case, because the release position is located on the target storage container label, the terminal determines the target virtual item and the target storage container label that are selected by the drag operation, and starts a batch item transfer procedure for all virtual items of the same type as the target virtual item. Alternatively, as the user drags the target virtual item, the terminal may not display that the target virtual item follows the finger of the user to move along the drag track, which is not specifically limited in this embodiment of this application.

In some other embodiments, the batch item transfer procedure may be further started in the following interaction manner: After the user presses the target virtual item in the first storage space for a long time that exceeds a pressing threshold, the user taps the target storage container label in the second storage space. The pressing threshold is any value greater than 0. That is, after the user presses the target virtual item in the first storage space long enough until the pressing threshold is exceeded, the second storage space prompts a tappable area such as a storage container label and an item storage area. If it is detected that the user taps the target storage container label, that a batch transfer operation needs to be performed on all virtual items of the same type as the target virtual item, so as to transfer all the virtual items of the same type as the target virtual item to the item storage area corresponding to the target storage container label. On the contrary, if it is detected that the user taps an item storage area in the second storage space, and the item storage area is necessarily corresponding to a specific storage container label, only the target virtual item needs to be transferred, but a virtual item of the same type does not need to be transferred. In this case, the long-pressed target virtual item is transferred to the tapped item storage area.

In an example scenario, as shown in FIG. 4, if a drag operation in which the user drags a target virtual item in the first storage space 410 to the second storage space 420 is detected, the terminal determines a release position of the drag operation. If the release position is on any target storage container label in the storage container labels 421-426, the user has a batch item transfer requirement, and then the terminal transfers all virtual items of the same type as the target virtual item to an item storage area corresponding to the target storage container label at a time. If the release position is located in the item storage area 4211, the user has a single item transfer requirement, and then the terminal transfers the target virtual item selected by the current drag operation to the item storage area 4211 without transferring a virtual item of the same type.

In the foregoing process, a drag operation of multiple different implementations is provided, so that one or more drag operations can be supported on the server, and a batch item transfer operation for all virtual items of the same type as the target virtual item can be triggered, thereby increasing a success rate of the batch item transfer operation. In addition, the user may further configure, according to a personalized operation habit, a drag operation supported by the terminal of the user, so as to improve adaptation between the drag operation and the user. Further, on the basis of supporting an interaction manner of a one-tap batch item transfer operation, an interaction manner of performing a transfer operation on a single item selected currently is still retained, so that the user can flexibly select an appropriate interaction manner according to an item transfer requirement of the user, thereby greatly improving user operation convenience and man-computer interaction efficiency.

In some embodiments, after the target virtual item selected by the drag operation is determined, the terminal uses the item identifier of the target virtual item as the item type of the target virtual item. For example, if the target virtual item selected by the drag operation is “straw cotton,” the item identifier 031 of “straw cotton” is used as the item type of the target virtual item. Further, the terminal queries, from the multiple virtual items stored in the first storage space, all the virtual items (that is, all the virtual items of the same type as the target virtual item) that have an item identifier.

In one example, as shown in FIG. 5, the user performs a drag operation of dragging the target virtual item 511 located in the upper left corner of the first storage space 510 onto the target storage container label 521 and releases the hand. In this case, the terminal determines the item identifier 031 of the target virtual item 511, that is, “straw cotton”, as the item type of the target virtual item. In this operation 304, the terminal queries the first storage space 510 to obtain all the “straw cotton” 511-518 with the item identifier 031, that is, the queried “straw cotton” 511-518 is all virtual items of the same type as the target virtual item 511.

In some other embodiments, the terminal may further store a mapping relationship between a virtual item and a type identifier. Further, after the terminal determines the target virtual item by the drag operation, the terminal queries, based on the foregoing mapping relationship, to obtain the type identifier associated with the target virtual item. Further, the terminal uses the type identifier obtained by means of query as the item type of the target virtual item. For example, if the target virtual item selected by the drag operation is “straw cotton”, the type identifier associated with “straw cotton” is “crop” 001, and the type identifier 001 is used as the item type of the target virtual item. A manner of obtaining the item type is not specifically limited in this embodiment of this application. Further, the terminal queries, from the multiple virtual items stored in the first storage space, all virtual items associated with the type identifier (that is, all the virtual items of the same type as the target virtual item).

In another example, as shown in FIG. 5, the user performs a drag operation of dragging the target virtual item 511 located in the upper left corner of the first storage space 510 onto the target storage container label 521 and releases the hand. In this case, the terminal determines that the type identifier “crop” 001 associated with the target virtual item 511 is used as the item type of the target virtual item. In this operation 304, the terminal queries the first storage space 510 to obtain all virtual items that have an association relationship with the type identifier “crop” 001, for example, finds the following virtual items: “straw cotton” 511-518 and “wheat” 531-535, that is, these queried “straw cotton” 511-518 and “wheat” 531-535 are all virtual items of the same type as the target virtual item 511.

In the foregoing process, a drag operation can be configured for enabling a batch transfer operation on all virtual items of the same type as the target virtual item. In this way, a single virtual item does not need to be manually repeatedly transferred by the user, but all virtual items of the same type as the target virtual item can be transferred to the item storage area corresponding to the target storage container label in the second storage space at a time, so that item transfer efficiency and human-computer interaction efficiency can be improved.

305. The terminal transfers all the at least one first-type virtual item from the first storage space to the first item storage area.

The at least one first-type virtual item is all virtual items of the foregoing item type, and refers to all virtual items of the same type as the target virtual item.

In some embodiments, the terminal removes all the virtual items of the same type as the target virtual item from the first storage space, and displays all the virtual items of the same type as the target virtual item in the item storage area corresponding to the target storage container label in the second storage space. In other words, the terminal removes the at least one first-type virtual item from the first storage space, and displays the at least one first-type virtual item in the first item storage area. For example, if each storage container label is displayed in the second storage space in a storage container list manner, all the virtual items of the same type as the target virtual item may be used as a drop-down expansion list entry of the target storage container label. The foregoing manner may reflect that all the virtual items of the same type as the target virtual item have been transferred from the first storage space to the item storage area corresponding to the target storage container label, thereby implementing visual display of an item transfer result, improving intuition of the item transfer result, and improving information obtaining efficiency of the user.

In some embodiments, when detecting that the release position of the drag operation is on the target storage container label, the terminal may set the interactive UI control of the target storage container label to the selected state, and display, in the second storage space, the item storage area corresponding to the target storage container label. In this case, when batch transfer is implemented on all the virtual items of the same type as the target virtual item, the terminal may remove all the virtual items of the same type as the target virtual item from the first storage space. That is, all the virtual items of the same type as the target virtual item are no longer displayed in the first storage space. In addition, the terminal displays all the virtual items of the same type as the target virtual item in the item storage area corresponding to the target item storage container label, which is equivalent to implementing, in a virtual scene, transfer of all the virtual items of the same type as the target virtual item from the first storage space to the second storage space. In addition, the user only needs to perform a drag operation once, so that all the virtual items of the same type as the target virtual item can be transferred at once, thereby improving human-computer interaction efficiency.

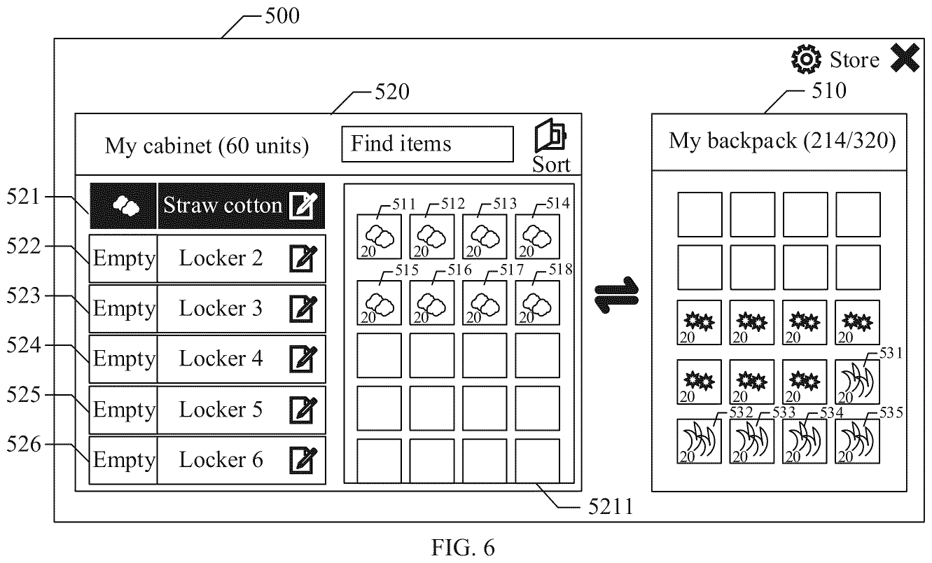

FIG. 6 is a schematic interface diagram of an item transfer result according to an embodiment of this application. As shown in FIG. 6, assuming that the user performs, on the virtual scene 500 shown in FIG. 5, a drag operation of dragging the target virtual item 511 in the first storage space 510 onto the target storage container label 521 in the second storage space 520 and releases the hand, the terminal is triggered to determine an item type of the target virtual item 511. It is assumed that the item type is the item identifier 031, that is, “straw cotton”. In this case, the terminal obtains all “straw cotton” 511-518 that is in the first storage space 510 and that has the item identifier 031 as all virtual items of the same type as the target virtual item 511. Further, all “straw cotton” 511-518 in FIG. 5 that is originally located in the first storage space 510 is removed from the first storage space 510. In addition, as shown in FIG. 6, the terminal displays all the foregoing “straw cotton” 511-518 (that is, all the virtual items of the same type as the target virtual item 511) to the item storage area 5211 corresponding to the target storage container label 521 in the second storage space 520.

In the foregoing process, all the virtual items of the same type as the target virtual item are visually transferred from the first storage space to the item storage area corresponding to the target storage container label in the virtual scene. In this way, batch transfer effects of all the virtual items of the same type as the target virtual item can be more visually displayed. The interactive UI control of the target storage container label is automatically switched to the selected state, the item storage area corresponding to the target storage container label is expanded, and all the virtual items of the same type as the target virtual item are displayed in the item storage area corresponding to the target storage container label. In this way, the user does not need to manually switch to select the target storage container label, which reduces cumbersomeness of an operation performed by the user, so that the user quickly learns, in this batch, which virtual items of the same type as the target virtual item are transferred currently, and all the virtual items of the same type as the target virtual item are transferred to an item storage area corresponding to which storage container label, thereby improving information obtaining efficiency of the user.

In some embodiments, after determining that a drag operation is performed on a currently selected target virtual item, and determining, in the first storage space, all the virtual items of the same type as the target virtual item, the terminal stores item numbers of all the virtual items of the same type as the target virtual item into one item number queue. Then, the terminal encapsulates the item number queue into a batch item transfer request, and sends the batch item transfer request to the server. In response to the batch item transfer request, the server obtains the item number queue by means of parsing, removes each item number in the item number queue from storage metadata in the first storage space, and adds each item number to storage metadata associated with the target storage container label in the second storage space. In the foregoing manner, batch transfer and storage of all the virtual items of the same type as the target virtual item can be implemented. Storage metadata of each storage space is configured for recording item numbers of all virtual items stored in the storage space.

The item number is configured for representing a specific number of the virtual item, and the item identifier is configured for representing a type of the virtual item. For example, an item identifier of a virtual item is 031, which represents that the virtual item is “straw cotton”, but an item number of the virtual item is 000010, which represents that the virtual item is the tenth virtual item collected by a virtual object.

In some other embodiments, the terminal encapsulates the item number and the item type of the target virtual item into the batch item transfer request, and sends the batch item transfer request to the server. The server obtains the item number and the item type of the target virtual item by means of parsing in response to the batch item transfer request. Then, the server queries the storage metadata of the first storage space, so as to determine all the virtual items of the same type as the target virtual item and stored in the first storage space, and deletes item numbers of all found virtual items of the same type as the target virtual item from the storage metadata of the first storage space. Then, the server adds, to the storage metadata associated with the target storage container label of the second storage space, the item numbers of all the virtual items of the same type as the target virtual item, so as to implement batch transfer and storage of all the virtual items of the same type as the target virtual item. In this way, the terminal does not need to perform an operation of determining all the virtual items of the same type as the target virtual item, and a processing resource of the terminal can be saved by transferring this operation to the server for implementation.

In some embodiments, the server returns a batch transfer success response to the terminal after deleting the item numbers of all the virtual items of the same type as the target virtual item from the storage metadata of the first storage space and adding them to the storage metadata associated with the target storage container label of the second storage space. In the virtual scene, in response to the batch transfer success response, the terminal removes all the virtual items of the same type as the target virtual item from the first storage space, and displays the virtual items in the item storage area corresponding to the target storage container label in the second storage space. In some embodiments, the batch transfer success response may be an acknowledge character (ACK) message.

In the foregoing operations 304-305, a possible implementation of transferring all the virtual items that are in the first storage space and that are of the same type as the target virtual item to the item storage area corresponding to the target storage container label is provided. That is, the item type of the target virtual item is obtained first, and then all the virtual items that have the item type are determined from the multiple virtual items stored in the first storage space. In the foregoing manner, it can be ensured that all items of the same type in the first storage space are traversed, so as to avoid missing an item of the same type. Further, the user needs to perform only one drag operation on the target virtual item, so that all the virtual items of the same type as the target virtual item can be transferred to the item storage area corresponding to the target storage container label at a time, and the user does not need to repeatedly perform the drag operation on each item of the same type for multiple times, thereby greatly improving item transfer efficiency and human-computer interaction efficiency.

Further, by means of interaction between the terminal and the server, the terminal displays a UI change in the virtual scene only after the server completes modifying and storing metadata. In this way, a local processing resource of the terminal can be saved. In some other embodiments, after locally modifying and storing the metadata, the terminal may synchronize the modified storage metadata to the server, or synchronize control information modified currently to the server. In this way, response efficiency of batch item transfer can be improved.

306. The terminal modifies a label name of the target storage container label, so that the label name is consistent with an item name of the target virtual item.

In some embodiments, the terminal may further determine the item name of the target virtual item. For example, the item name of the target virtual item is “straw cotton”, and further, the determined item name “straw cotton” is set as the label name of the target storage container label. That is, the name of the target virtual item is set as the label name of the target storage container label. As shown in FIG. 6, it can be seen that the label name of the target storage container label is automatically changed from the initial “locker 1” to “straw cotton”. In this way, instead of manually setting the label name of the target storage container label by the user, after the user performs the drag operation, the terminal automatically completes a setting operation on the label name of the target storage container label, thereby improving human-computer interaction efficiency.

In some other embodiments, the terminal sets the item name of the target virtual item as the label name of the target storage container label only when it is detected that the label name of the target storage container label is the initial name. For example, it is assumed that before the user performs the drag operation, the label name of the target storage container label is the initial name “locker 1”. After the user performs the drag operation, all the virtual items of the same type as the target virtual item are batch transferred to the item storage area corresponding to the target storage container label, and the label name of the target storage container label is changed to the item name of the target virtual item, such as “straw cotton”. For another example, it is assumed that before the user performs the drag operation, the label name of the target storage container label is not the initial name. For example, the user has changed the target storage container label from the initial name “locker 1” to “crop”. After the user performs the drag operation, because it is detected that the label name of the target storage container label is not the initial name, the terminal does not automatically modify the label name of the target storage container label. That is, the label name of the target storage container label remains the original name “crop”.

In some other embodiments, after batch item transfer is performed, the terminal sets the item name of the target virtual item to the label name of the target storage container label only when it is detected that the item storage area corresponding to the target storage container label includes a virtual item of the same item type. For example, it is assumed that the item storage area corresponding to the target storage container label already stores 10 services of “straw cotton”, and eight services of “straw cotton” are transferred in batches by using a drag operation. After batch item transfer, the item storage area corresponding to the target item storage container label still includes only the same type of virtual item “straw cotton”. Therefore, the item name of the target virtual item is automatically set to the label name of the target item storage container label. For another example, it is assumed that the item storage area corresponding to the target storage container label already stores 10 services of “wheat”, and eight services of “straw cotton” are transferred in batches by using a drag operation. After batch item transfer, because the item storage area corresponding to the target storage container label includes two or more types of virtual items, the terminal does not automatically modify the label name of the target item container label.

In some other embodiments, after batch item transfer is performed, when detecting that the item storage area corresponding to the target storage container label includes two or more item types of virtual items, the terminal may count a storage quantity of virtual items of each item type, and automatically set an item name of a virtual item with a largest storage quantity to the label name of the target item container label. For example, it is assumed that the item storage area corresponding to the target storage container label already stores 10 services of “wheat”, and eight services of “straw cotton” are transferred in batches by using a drag operation. In this case, if the virtual item with the largest storage quantity is “wheat”, “wheat” is automatically set as the label name of the target storage container label. In some other embodiments, the terminal may further set the label name of the target storage container label to item names of two or more item types of virtual items stored in the item storage area corresponding to the target storage container label. For example, it is assumed that the item storage area corresponding to the target storage container label already stores 10 services of “wheat”, and eight services of “straw cotton” are transferred in batches by using a drag operation. Then, the label name of the target storage container label is set to “wheat & straw cotton”. A manner of setting the label name of the target storage container label is not specifically limited in this embodiment of this application.

307. The terminal modifies a label icon of the target storage container label, so that the label icon is consistent with an item icon of the target virtual item.

In some embodiments, the terminal may further determine the item icon of the target virtual item. For example, the item icon of the target virtual item is a straw cotton pattern, and further, the determined straw cotton pattern is set as the label icon of the target storage container label. As shown in FIG. 6, it can be seen that the label icon of the target storage container label is automatically changed from initial “empty” to “straw cotton pattern”. In the foregoing manner, instead of manually setting the label icon of the target storage container label by the user, after the user performs the drag operation, the terminal automatically completes a setting operation on the label icon of the target storage container label, thereby improving human-computer interaction efficiency.

In some other embodiments, the terminal sets the item icon of the target virtual item as the label icon of the target storage container label only when it is detected that the label icon of the target storage container label is the initial icon. For example, it is assumed that before the user performs the drag operation, the label icon of the target storage container label is the initial icon “empty”. After the user performs the drag operation, all the virtual items of the same type as the target virtual item are batch transferred to the item storage area corresponding to the target storage container label, and the label icon of the target storage container label is changed to the item icon of the target virtual item, such as “straw cotton pattern”. For another example, it is assumed that before the user performs the drag operation, the label icon of the target storage container label is not the initial icon. For example, the user has changed the target storage container label from the initial icon “empty” to a plant pattern. After the user performs the drag operation, because it is detected that the label icon of the target storage container label is not the initial icon, the terminal does not automatically modify the label icon of the target storage container label. That is, the label icon of the target storage container label remains the original plant pattern.

In some other embodiments, after batch item transfer is performed, the terminal sets the item icon of the target virtual item to the label icon of the target storage container label only when it is detected that the item storage area corresponding to the target storage container label includes a virtual item of the same item type. For example, it is assumed that the item storage area corresponding to the target storage container label already stores 10 services of “straw cotton”, and eight services of “straw cotton” are transferred in batches by using a drag operation. After batch item transfer, the item storage area corresponding to the target item storage container label still includes only the same type of virtual item “straw cotton”. Therefore, the item icon of the target virtual item, that is, straw cotton, is automatically set to the label icon of the target item storage container label. For another example, it is assumed that the item storage area corresponding to the target storage container label already stores 10 services of “wheat”, and eight services of “straw cotton” are transferred in batches by using a drag operation. After batch item transfer, because the item storage area corresponding to the target storage container label includes two or more types of virtual items, the terminal does not automatically modify the label icon of the target item container label.

In some other embodiments, after batch item transfer is performed, when detecting that the item storage area corresponding to the target storage container label includes two or more item types of virtual items, the terminal may count a storage quantity of virtual items of each item type, and automatically set an item icon of a virtual item with a largest storage quantity to the label icon of the target item container label. For example, it is assumed that the item storage area corresponding to the target storage container label already stores 10 services of “wheat”, and eight services of “straw cotton” are transferred in batches by using a drag operation. In this case, if the virtual item with the largest storage quantity is “wheat”, the wheat pattern is automatically set as the label icon of the target storage container label. A manner of setting the label icon of the target storage container label is not specifically limited in this embodiment of this application.

In this embodiment of this application, by controlling a release position of a drag operation, when the release position is located on a storage container label rather than an item storage area, the user can quickly complete batch transfer of all the virtual items of the same type as the target virtual item from the first storage space to the second storage space. As shown in FIG. 5, for example, after the user drags the target virtual item 511 onto the target storage container label 521 and releases the hand, it is considered that all virtual items 511-518 of the same type as the target virtual item 511 are transferred to the item storage area 5211 corresponding to the target storage container label 521. As shown in FIG. 6, it may be learned that all virtual items 511-518 of the same type as the target virtual item 511 are already displayed in the item storage area 5211 corresponding to the target item storage container label 521, and an item name “straw cotton” of the target virtual item is used as the label name of the target item storage container label 521, and an item icon straw cotton pattern of the target virtual item is used as the label icon of the target item storage container label 521.

All the foregoing technical solutions can be randomly combined to form exemplary embodiments of the present disclosure, and details are not described herein.

According to the method provided in this embodiment of this application, when a drag operation from one storage space to another storage space is detected, based on different release positions of the drag operation, a single transfer operation for a currently selected virtual item and a batch transfer operation for all virtual items of the same type are separately provided. That is, when the release position is located in an item storage area, only the currently selected virtual item is transferred; when the release position is located on a storage container label, all the virtual items of the same type are transferred in batches, so that a user can control the release position of the drag operation, to flexibly control which virtual items need to be transferred in batches currently. In addition, batch transfer of items of the same type can be controlled by using only one drag operation. This prevents the user from manually repeatedly performing an item transfer operation for multiple times, thereby reducing operation cumbersomeness of the user, and improving item transfer efficiency and human-computer interaction efficiency.

In the foregoing embodiment, an operation manner in which the user quickly transfers all items of the same type is described in detail. By controlling a release position of a drag operation to be located on a storage container label, the user can quickly complete batch transfer of all the virtual items of the same type as the target virtual item from the first storage space to the second storage space. In this embodiment of this application, an operation procedure for batch retrieving all virtual items of the same type from the second storage space to the first storage space is proposed, and is described in the following.

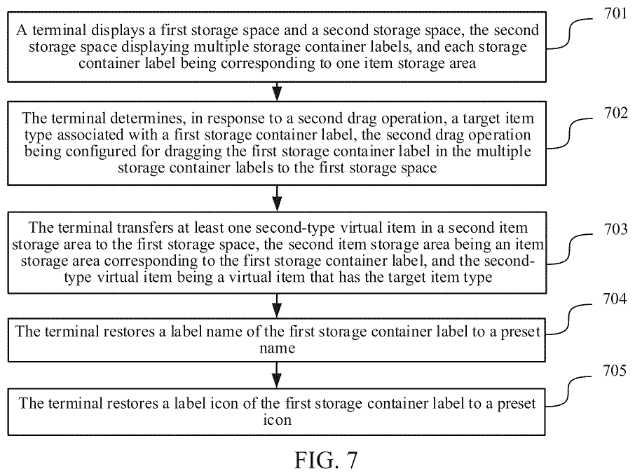

FIG. 7 is a flowchart of a method for transferring a virtual item according to an embodiment of this application. Referring to FIG. 7, this embodiment is performed by an electronic device. The following uses an example in which the electronic device is a terminal for description. This embodiment includes the following operations:

701. The terminal displays a first storage space and a second storage space, the second storage space displaying multiple storage container labels, and each storage container label being corresponding to one item storage area.

A manner of displaying the storage space in operation 701 is the same as the manner of displaying the storage space in operation 301 in the foregoing embodiment, and details are not described herein again.

702. The terminal determines, in response to a second drag operation, a target item type associated with a first storage container label, the second drag operation being configured for dragging the first storage container label in the multiple storage container labels to the first storage space.

In some embodiments, a finger of a user first touches and presses the first storage container label displayed in the second storage space. The first storage container label may be any storage container label in the second storage space. For example, the label may be a target storage container label involved in a batch item transfer operation in the foregoing embodiment, or may be another storage container label. Then, after detecting a pressure signal applied by the finger of the user to a screen of the terminal, a touch sensor of the terminal determines a touch point associated with the pressure signal as the start position of the drag operation. Then, the terminal continuously senses, by using the touch sensor, the pressure signal applied by the finger of the user. Because the finger of the user slides dynamically, the terminal can determine a drag track of the finger of the user based on a series of touch points sensed in real time. Then, when the touch sensor does not sense the pressure signal for more than preset duration, indicating that the finger of the user leaves the screen of the terminal (that is, the drag operation stops and the drag operation ends), in this case, the terminal determines a release position of the drag track. The preset duration is any value greater than 0.

In some embodiments, after the start position and the release position of the drag track are determined in the foregoing manner, if screen coordinates of the start position are located on the first storage container label in the second storage space and screen coordinates of the release position are located in the first storage space, it is determined that a drag operation of dragging the first storage container label to the first storage space is detected, that is, the second drag operation. In response to the second drag operation, the terminal determines the storage container label associated with the start position as the first storage container label selected by the second drag operation. The storage container label associated with the start position refers to that screen coordinates of the start position are located in a display area of an interactive UI control of which storage container label in the second storage space.

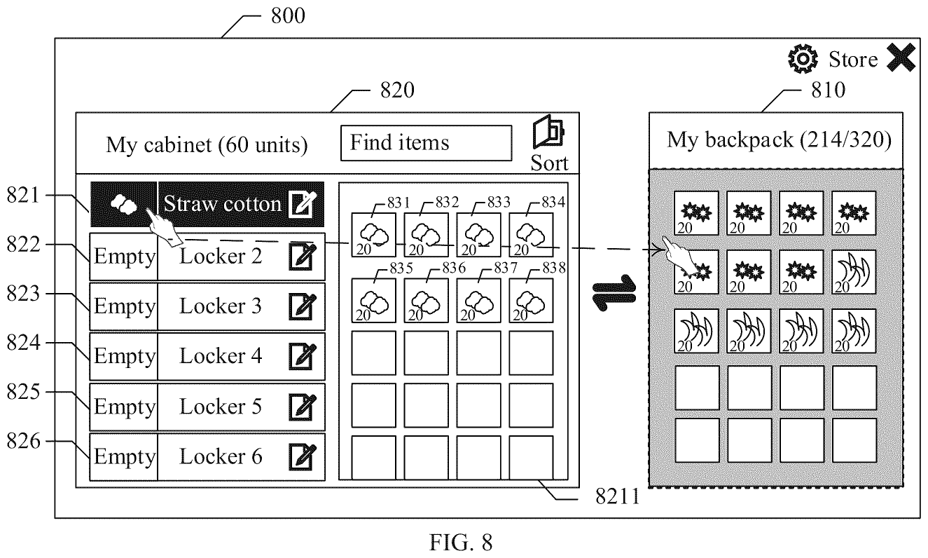

FIG. 8 is a schematic principle diagram of a drag operation according to an embodiment of this application. As shown in FIG. 8, in a virtual scene 800, a first storage space 810 and a second storage space 820 are displayed. In addition, six storage container labels 821-826 are displayed in the second storage space 820. Currently, an interactive UI control of the storage container label 821 is in a selected state. Therefore, an item storage area 8211 of the selected storage container label 821 is further displayed in the second storage space 820. Further, the storage container label 821 is used as the first storage container label as an example for description. It is assumed that the user performs an operation of dragging the first storage container label 821 in the second storage space 820 to any position in the first storage space 810 and releases the hand, and the terminal obtains, in response to the drag operation, a target item type associated with the first storage container label 821, and batch retrieves all virtual items that are in an item storage area corresponding to the first storage container label 821 and that have the target item type into the first storage space 810.

In the foregoing process, a possible implementation in which the user drags a storage container label of the second storage space to any position in the first storage space, so as to trigger a drag operation to enable a subsequent batch item retrieval procedure is shown. In this implementation, only when the user drags the storage container label to the first storage space by using a drag operation, a batch item retrieval procedure is triggered. However, when the user drags a single virtual item in an item storage area corresponding to a storage container label to the first storage space, a single item retrieval procedure may still be supported. In other words, only a drag operation of dragging the storage container label to the first storage space triggers batch retrieval of all virtual items that are in the item storage area corresponding to the first storage container label and have the target item type associated with the item. However, a drag operation of dragging a virtual item in an item storage area to the first storage space only triggers retrieval of a single virtual item dragged currently (one service of virtual items may be one or more). Different item retrieval procedures are started by providing different trigger manners, so that the user can perform a corresponding trigger operation according to an item retrieval requirement of the user, which has higher flexibility and operability.

In some embodiments, the user drags the first storage container label of the second storage space to any position in the first storage space and releases the hand, and can trigger a drag operation of dragging the first storage container label to the first storage space. In some other embodiments, even if the user does not release the hand after dragging the first storage container label to the first storage space, it is also considered that a drag operation of dragging the first storage container label to the first storage space is detected as long as the terminal detects that the start position of the drag track is located in the display area of the interactive UI control of the first storage container label in the second storage space, and the latest touch point of the drag track (which may not necessarily be a release position, because the user may keep the touch state continuously, that is, the user does not release the hand) is located in the first storage space. This embodiment of this application sets no specific limitation on whether the user needs to release the hand to trigger a drag operation.

In some other embodiments, as the user drags the first storage container label, the terminal may further display that the first storage container label follows the finger of the user to move along the drag track until the first storage container label is dragged into the first storage space. In this case, the terminal starts a process of retrieving all virtual items of the target item type in the item storage area corresponding to the first storage container label. Alternatively, as the user drags the first storage container label, the terminal may not display that the first storage container label follows the finger of the user to move along the drag track. This is not specifically limited in this embodiment of this application.

In some other embodiments, the batch item retrieval procedure may be further started in the following interaction manner: After pressing the interactive UI control of the first storage container label in the second storage space for a long time that exceeds a pressing threshold, the user taps any position in the first storage space. The pressing threshold is any value greater than 0. That is, after the user long presses the interactive UI control of the first storage container label until the pressing threshold is exceeded, the terminal screen prompts the first storage space as a tappable area. If it is detected that the user taps any position in the first storage space, a batch retrieval operation needs to be performed on all the virtual items that have the target item type in the item storage area corresponding to the first storage container label, so that a storage container label corresponding to the interactive UI control that is long pressed by the user is used as the first storage container label selected by the drag operation, and a subsequent batch retrieval procedure is performed.

In the foregoing process, a drag operation is provided in multiple different implementations, so that one or more drag operations can be supported on a server, and can trigger a batch item retrieval operation on all the virtual items of the target item type in the item storage area corresponding to the first storage container label, thereby increasing a success rate of the batch item retrieval operation. In addition, the user may further configure, according to a personalized operation habit, a drag operation supported by the terminal of the user, so as to improve adaptation between the drag operation and the user. Further, on the basis of supporting an interaction manner of a one-tap batch item retrieval operation, an interaction manner of performing a retrieval operation on a single item selected in an item storage area is still retained, for example, a drag operation of dragging a virtual item displayed in an item storage area to the first storage space triggers a procedure of retrieving a single virtual item to the first storage space from the second storage space, so that the user can flexibly select an appropriate interaction manner according to an item retrieval requirement of the user, thereby greatly improving user operation convenience and man-computer interaction efficiency.

In some embodiments, after determining the first storage container label selected by the drag operation, the terminal may determine, as the target item type, an item type of a virtual item associated with a label name of the first storage container label. That is, when performing the drag operation on the first storage container label, the user most likely wants to batch retrieve all virtual items of the same type that are associated with the label name. An item type of the virtual item associated with the label name is determined as the target item type, so that accuracy of obtaining the target item type can be improved. For example, if the label name of the first storage container label is “straw cotton”, the item type associated with “straw cotton”, that is, the item identifier 031 is used as the target item type.

In some other embodiments, the terminal may further determine an item type of a virtual item associated with a label icon of the first storage container label as the target item type. That is, when performing the drag operation on the first storage container label, the user most likely wants to batch retrieve all virtual items of the same type that are associated with the label icon, and determines an item type of the virtual item associated with the label icon as the target item type. In this way, accuracy of obtaining the target item type can also be improved. For example, if the label icon of the first storage container label is a straw cotton pattern, the item type associated with the straw cotton pattern, that is, the item identifier 031 is used as the target item type.

In some other embodiments, the terminal may further determine an item type of a virtual item with a largest storage quantity in the item storage area corresponding to the first storage container label as the target item type. That is, when the item storage area corresponding to the first storage container label includes two or more item types of virtual items, the terminal determines an item type of a virtual item with a largest storage quantity as the target item type. For example, the item storage area corresponding to the first storage container label includes 20 services of “straw cotton” and 10 services of “wheat”. Then, when a drag operation of dragging the first storage container label to the first storage space is detected, an item type of the virtual item “straw cotton” with a largest storage quantity, that is, the item identifier 031, is used as the target item type. In this way, a possible implementation of determining the target item type when the item storage area corresponding to the first storage container label includes two or more item types of virtual items is provided, which expands applicable scenarios in which items are retrieved in batches. A manner of obtaining the target item type is not specifically limited in this embodiment of this application.

In the foregoing operation 702, the drag operation of dragging the first storage container label to the first storage space can enable, with one tap, a batch retrieval operation on all virtual items of the target item type in the item storage area corresponding to the first storage container label. In this way, the user does not need to manually and repeatedly retrieve each virtual item of the target item type for multiple times. Instead, all virtual items of the target item type that are associated with the selected first storage container label can be retrieved together to the first storage space at a time, thereby improving item retrieval efficiency and human-computer interaction efficiency.

703. The terminal transfers at least one second-type virtual item in a second item storage area to the first storage space, the second item storage area being an item storage area corresponding to the first storage container label, and the second-type virtual item being a virtual item that has the target item type.

In some embodiments, after detecting the drag operation of dragging the first storage container label to the first storage space, the terminal may determine the first storage container label selected by the drag operation. The terminal determines, by using the foregoing operation 702, the target item type associated with the first storage container label. Then, the terminal obtains all the virtual items of the target item type from all the virtual items stored in the item storage area corresponding to the first storage container label. Thereafter, the terminal may remove, from the item storage area corresponding to the first storage container label displayed in the second storage space, all the virtual items of the target item type, that is, all the virtual items of the target item type are no longer displayed in the item storage area corresponding to the first storage container label. In addition, that the terminal displays, in the first storage space, all the virtual items of the target item type is equivalent to that in a virtual scene, all the virtual items of the target item type are transferred from the second storage space to the first storage space. In addition, the user only needs to perform a drag operation on the storage container label once, so that all the virtual items of the target item type can be transferred at once.

In this embodiment of this application, description is provided only by using an example in which all virtual items that are of the target item type and that are obtained in batches are the same as all virtual items that are of the same type as the target virtual item and that are transferred in batches in the previous embodiment. In other words, by using a drag operation of dragging the target virtual item from the first storage space to the target storage container label, all the virtual items of the same type as the target virtual item can be batch transferred to the second storage space at a time. That the first storage container label is the target storage container label is used as an example. By using a drag operation of dragging the target storage container label to the first storage space, all virtual items (that is, all virtual items of the target item type, where the target item type in this case is the item type of the target virtual item) of the same type as the target virtual item can be retrieved into the first storage space in batches at a time, but this is not to constitute a limitation that the virtual items retrieved in batches and the virtual items transferred in batches are the same items. For example, in the foregoing embodiment, 10 services of straw cotton are transferred in batches from the first storage space to an item storage area corresponding to a storage container label A in the second storage space. Thereafter, by using the method in this embodiment of this application, the user retrieves 20 services of “wheat” in batches from an item storage area corresponding to another storage container label B in the second storage space to the first storage space.

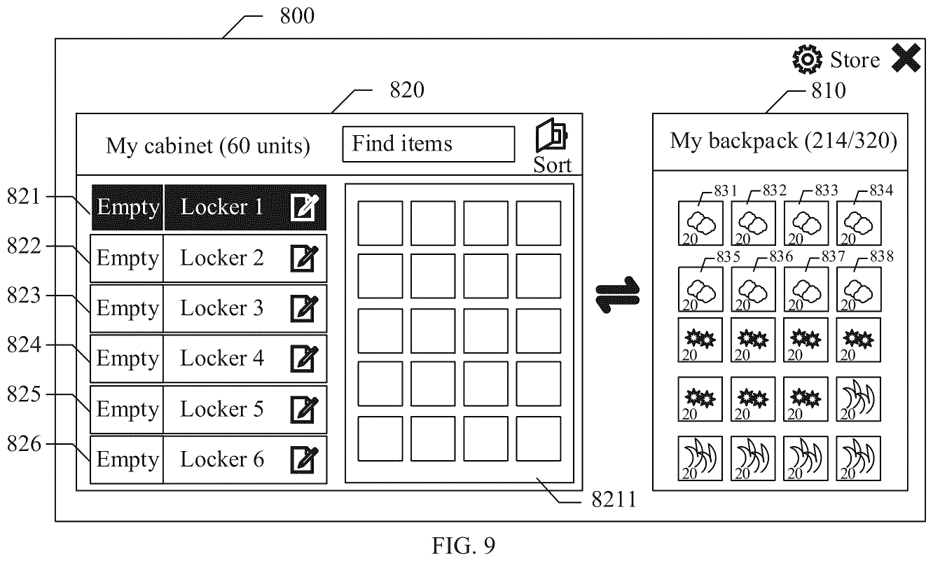

FIG. 9 is a schematic interface diagram of an item retrieval result according to an embodiment of this application. As shown in FIG. 9, assuming that the user performs, on a virtual scene 800 shown in FIG. 8, a drag operation of dragging a first storage container label 821 in a second storage space 820 to any position in a first storage space 810 and releases the hand, the terminal is triggered to determine a target item type associated with the first storage container label 821, such as “straw cotton”. That is, the target item type is the item identifier 031 of “straw cotton”. Then, the terminal obtains all “straw cotton” 831-838 that is in the item storage area corresponding to the first storage container label 821 and that has the item identifier 031 as all virtual items of the target item type. Further, the terminal removes all the virtual items 831-838 of the target item type that are in an item storage area 8211 corresponding to the first storage container label 821 in FIG. 8. In addition, as shown in FIG. 9, the terminal displays all the virtual items 831-838 of the target item type in the first storage space 810.

In the foregoing process, all virtual items of the target item type are intuitively retrieved from the item storage area corresponding to the first storage container label in the virtual scene to the first storage space, so that a batch retrieval effect of all the virtual items of the target item type can be visually displayed, so that the user quickly learns which virtual items are transferred in the current batch and which storage space the virtual item is transferred to, thereby improving information obtaining efficiency of the user.

In some embodiments, after determining all the virtual items of the target item type from all the virtual items included in the item storage area corresponding to the first storage container label, the terminal stores item numbers of the virtual items of the target item type into one item number queue. Then, the terminal encapsulates the item number queue into a batch item retrieval request, and sends the batch item retrieval request to the server. In response to the batch item retrieval request, the server obtains the item number queue by means of parsing, removes each item number in the item number queue from storage metadata associated with the first storage container label in the second storage space, and adds multiple item numbers to storage metadata in the first storage space, so that all the virtual items of the target item type are retrieved from the second storage space to the first storage space in batches. Storage metadata of each storage space is configured for recording item numbers of all virtual items stored in the storage space.

The item number is configured for representing a specific number of the virtual item, and the item identifier is configured for representing a type of the virtual item. For example, an item identifier of a virtual item is 031, which represents that the virtual item is “straw cotton”, but an item number of the virtual item is 000010, which represents that the virtual item is the tenth virtual item collected by a virtual object.

In some other embodiments, the terminal encapsulates the target item type and the first storage container label that are obtained in operation 702 into a batch item retrieval request, and sends the batch item retrieval request to the server. The server obtains the target item type and the first storage container label by means of parsing in response to the batch item retrieval request. Then, the server queries the storage metadata associated with the first storage container label in the second storage space, so as to determine all the virtual items of the target item type that are stored in the first storage container label, and deletes item numbers of the queried virtual items of the target item type from the storage metadata associated with the first storage container label. Then, the server adds the item numbers of all the virtual items of the target item type to the storage metadata of the first storage space, so that all the virtual items of the target item type are retrieved from the second storage space to the first storage space in batches. In this way, the terminal does not need to perform an operation of determining all the virtual items of the target item type. By transferring the foregoing determining operation to the server for execution, a processing resource of the terminal can be saved.

In some embodiments, after deleting the item numbers of all the virtual items of the target item type from the storage metadata associated with the first storage container label, and adding them to the storage metadata of the first storage space, the server returns a batch retrieval success response to the terminal. In a virtual scene, in response to the batch retrieval success response, the terminal removes all the virtual items of the target item type from the item storage area corresponding to the first storage container label in the second storage space, and displays the virtual items in the first storage space. In some embodiments, the batch retrieval success response may be an ACK message.

In the foregoing process, a possible implementation in which the terminal retrieves all the virtual items of the target item type from the second storage space to the first storage space is provided. By means of interaction between the terminal and the server, the terminal displays a UI change in the virtual scene only after the server completes modifying and storing metadata. In this way, a local processing resource of the terminal can be saved. In some other embodiments, after locally modifying and storing the metadata, the terminal may synchronize the modified storage metadata to the server, or synchronize control information modified at currently to the server. In this way, response efficiency of batch item retrieval can be improved.

704. The terminal restores a label name of the first storage container label to a preset name.

In some embodiments, when the label name of the first storage container label is the same as the label name of all the virtual items of the target item type that are retrieved in the current batch, the terminal may restore the label name of the first storage container label to the preset name. For example, the preset name may be an initial name. In an example, after all the virtual items of the target item type are retrieved in batches from the item storage area corresponding to the first storage container label to the first storage space, the label name of the first storage container label automatically recovers from “straw cotton” shown in FIG. 8 to the preset name “locker 1” shown in FIG. 9. In the foregoing manner, the user does not need to manually update the label name of the first storage container label. Instead, after the user performs a drag operation of dragging the first storage container label to the first storage space, the terminal automatically restores the label name of the first storage container label to an initialization configuration, thereby avoiding misunderstanding by the user. For example, the user is prevented from thinking that straw cotton is still stored in locker 1, thereby improving human-computer interaction efficiency.

In some other embodiments, when the label name of the first storage container label is not the same as the label name of all the virtual items of the target item type that are retrieved in the current batch, the terminal does not need to restore the label name of the first storage container label to the preset name. For example, the label name of the first storage container label is “crop”, and the item name of all the virtual items of the target item type that are retrieved in batches is “straw cotton”. After the user performs the drag operation of dragging the first storage container label to the first storage space, because it is detected that the label name and the item name are different, the terminal does not restore the label name of the first storage container label to the initialization configuration. That is, the label name of the first storage container label remains the original name “crop”.

In some other embodiments, after all the virtual items of the target item type are batch retrieved to the first storage space, if another virtual item is still stored in the item storage area corresponding to the first storage container label, the terminal may determine a first virtual item with a largest storage quantity from the another virtual item stored in the item storage area corresponding to the first storage container label. Then, the terminal sets the label name of the first storage container label to an item name of the first virtual item. For example, it is assumed that 10 services of “straw cotton”, eight services of “wheat”, and two services of “roses” are originally stored in the item storage area corresponding to the first storage container label. After the 10 services of “straw cotton” are retrieved to the first storage space in batches, the item storage area corresponding to the first storage container label still includes other virtual items, that is, the eight services of “wheat” and the two services of “roses”. In this case, it is determined from the other virtual items that the first virtual item with the largest storage quantity is “wheat”. Therefore, the label name of the first storage container label is updated from the original “straw cotton” to the item name “wheat” of the first virtual item.

705. The terminal restores a label icon of the first storage container label to a preset icon.

In some embodiments, when the label icon of the first storage container label is the same as the label icon of all the virtual items of the target item type that are retrieved in the current batch, the terminal may restore the label icon of the first storage container label to the preset icon. For example, the preset icon may be an initial icon. In an example, after all the virtual items of the target item type are retrieved in batches from the item storage area corresponding to the first storage container label to the first storage space, the label icon of the first storage container label automatically recovers from the straw cotton pattern shown in FIG. 8 to the preset icon “empty” shown in FIG. 9. In the foregoing manner, the user does not need to manually update the label icon of the first storage container label. Instead, after the user performs a drag operation of dragging the first storage container label to the first storage space, the terminal automatically restores the label icon of the first storage container label to an initialization configuration, thereby avoiding misunderstanding by the user. For example, the user is prevented from thinking that straw cotton is still stored in locker 1, thereby improving human-computer interaction efficiency.

In some other embodiments, when the label icon of the first storage container label is not the same as the label icon of all the virtual items of the target item type that are retrieved in the current batch, the terminal does not need to restore the label icon of the first storage container label to the preset icon. For example, the label icon of the first storage container label is a plant pattern, and the item icon of all the virtual items of the target item type that are retrieved in batches is a straw cotton pattern. After the user performs the drag operation of dragging the first storage container label to the first storage space, because it is detected that the label icon and the item icon are different, the terminal does not restore the label icon of the first storage container label to the initialization configuration. That is, the label icon of the first storage container label remains the plant pattern.

In some other embodiments, after all the virtual items of the target item type are batch retrieved to the first storage space, if another virtual item is still stored in the item storage area corresponding to the first storage container label, the terminal may determine a first virtual item with a largest storage quantity from the another virtual item stored in the item storage area corresponding to the first storage container label. Then, the terminal sets the label icon of the first storage container label to an item icon of the first virtual item. For example, it is assumed that 10 services of “straw cotton”, eight services of “wheat”, and two services of “roses” are originally stored in the item storage area corresponding to the first storage container label. After the 10 services of “straw cotton” are retrieved to the first storage space in batches, the item storage area corresponding to the first storage container label still includes other virtual items, that is, the eight services of “wheat” and the two services of “roses”. In this case, it is determined from the other virtual items that the first virtual item with the largest storage quantity is “wheat”. Therefore, the terminal updates the label icon of the first storage container label from the original straw cotton pattern to the item icon of the first virtual item, that is, the wheat pattern.

In this embodiment of this application, a drag operation of dragging the first storage container label to the first storage space can be performed, so that the user can quickly retrieve, from the item storage area corresponding to the first storage container label of the second storage space, all the virtual items of the target item type to the first storage space. As shown in FIG. 8, for example, when the user drags the first storage container label 821 to the first storage space 810 and releases the hand, it is considered that all same-type items 831-838 of the target item type “straw cotton” associated with the first storage container label 821 are retrieved to the first storage space 810 in batches. As shown in FIG. 9, it can be seen that all same-type items 831-838 are already displayed in the first storage space 810, the label name of the first storage container label 821 is restored to the initial name “locker 1”, and the label icon of the first storage container label 821 is restored to the initial icon “empty”.

All the foregoing technical solutions can be randomly combined to form exemplary embodiments of the present disclosure, and details are not described herein.

According to the method provided in this embodiment of this application, an interaction manner of triggering batch retrieval of all the virtual items of the target item type associated with the storage container label based on the drag operation of dragging the storage container label in the second storage space to the first storage space is provided, so that the user can perform only one drag operation of dragging the storage container label back to the first storage space, and all same-type virtual items of the target item type associated with the selected storage container label, that is, all the virtual items of the target item type associated with the selected storage container label, can be batch retrieved to the first storage space at a time, thereby avoiding that the user manually repeatedly performs an item retrieval operation for multiple times, reducing cumbersomeness of operations of the user, and improving item retrieval efficiency and human-computer interaction efficiency.

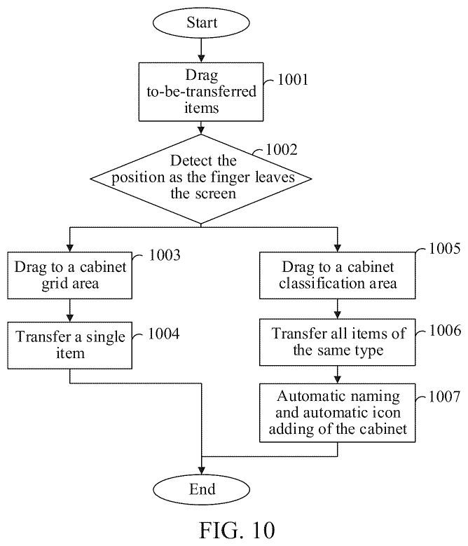

In the foregoing two embodiments, the batch item transfer procedure from the first storage space to the second storage space, and the batch item retrieval procedure from the second storage space to the first storage space are respectively described. In this embodiment of this application, an overall procedure of a batch item transfer manner and a single item transfer manner is described. FIG. 10 is a principle flowchart of a method for transferring a virtual item according to an embodiment of this application. As shown in FIG. 10, an example in which a first storage space is a backpack of a virtual object and a second storage space is a cabinet of the virtual object is configured for description.

Operation 1001: A user drags a to-be-transferred virtual item in the backpack.

Operation 1002: A terminal detects a position at which the user's finger leaves a screen of the terminal, that is, the terminal detects a release position of the drag operation.

Operation 1003: The user drags the virtual item to a grid area of the cabinet, that is, the user drags the virtual item to an item storage area of a locker in the cabinet.

Operation 1004: The terminal transfers a single virtual item dragged currently from the backpack to a corresponding locker. The locker is an example description of an item storage area corresponding to a storage container label.

Operation 1005: The user drags the virtual item to a cabinet classification area, that is, the user drags the virtual item to any storage container label in the cabinet.

Operation 1006: The terminal transfers all virtual items of the same type as the virtual item dragged currently from the backpack to the corresponding locker.

Operation 1007: The terminal automatically names the locker and adds an icon to the locker in the cabinet, that is, the terminal automatically configures a container name and a container icon for a storage container.

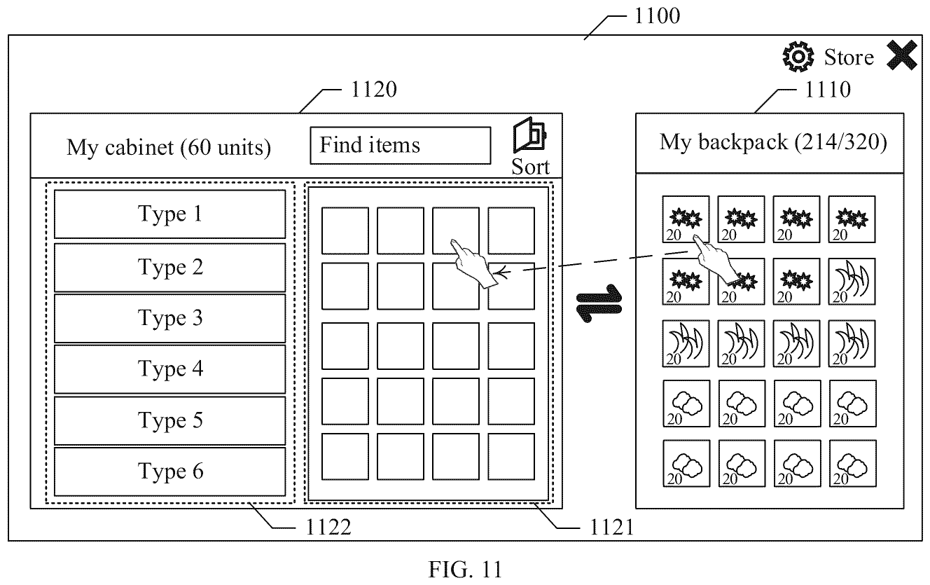

FIG. 11 is a principle interface diagram of an item transfer procedure according to an embodiment of this application. As shown in FIG. 11, in a virtual scene 1100, a backpack area 1110 and a cabinet area 1120 are displayed, where the backpack area 1110 is an example description of a first storage space, and the cabinet area 1120 is an example description of a second storage space. Multiple virtual items stored in a backpack are displayed in the backpack area 1110. A cabinet grid area 1121 and a cabinet classification area 1122 are displayed in the cabinet area 1120. The cabinet grid area 1121 is an example description of an item storage area corresponding to a storage container label. The cabinet classification area 1122 is an example description of an area that displays a storage container label in the second storage space. If it is detected that the user drags a target virtual item in the backpack to the cabinet grid area 1121 and releases the hand, a process of transferring the dragged target virtual item to a corresponding locker in a cabinet is triggered. If it is detected that the user drags the target virtual item in the backpack to the cabinet classification area 1122 and releases the hand, a process of triggering one-time batch transfer of all virtual items of the same type as the target virtual item that is dragged currently to a corresponding locker in the cabinet is triggered.

In this embodiment of this application, when it is detected that a user drags a single virtual item in the backpack, it is determined whether a release position of the user when the user releases the hand is in the cabinet grid area or the cabinet classification area. If it is detected that the release position is in the cabinet grid area, the dragged single virtual item is transferred to the corresponding locker of the cabinet. If it is detected that the release position is in an area that displays the storage container label, it is determined again that the release position when the hand is released falls specifically on which locker, that is, a storage container label, all virtual items in the backpack that are of the same type as the virtual item dragged currently are transferred to the determined locker, and the locker is automatically named and an icon is automatically added thereto. For example, an item name of the dragged virtual item is read, and is filled in a locker name of the locker; and an item icon of the dragged virtual item is read, and is filled in a locker icon of the locker.

In this embodiment of this application, the user does not need to repeatedly transfer the virtual items for multiple times, thereby greatly reducing cumbersomeness of operations for transferring the batch of items, implementing an interactive manner in which all virtual items of the same type can be quickly transferred by the user only by dragging a single service of virtual item, and greatly improving operation efficiency of transferring the items in batch by the user. Further, by reading an item name and an item icon of a virtual item that is dragged at a single time, and filling them in a cabinet name and a cabinet icon of a corresponding locker, automatic naming and automatic icon adding of a locker in a cabinet are implemented, and the user does not need to manually name the locker and set the locker icon, thereby further improving human-computer interaction efficiency.

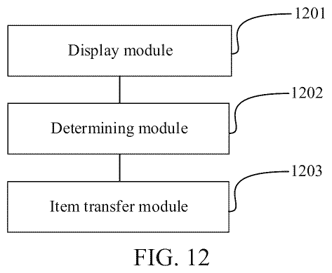

FIG. 12 is a schematic structural diagram of an apparatus for transferring a virtual item according to an embodiment of this application. As shown in FIG. 12, the apparatus includes:
a display module 1201, configured to display a first storage space and a second storage space, the first storage space displaying multiple virtual items, the second storage space displaying multiple storage container labels, and each storage container label corresponding to one item storage area;
a determining module 1202, configured to: determine a release position of a first drag operation in response to the first drag operation, the first drag operation being configured for dragging a target virtual item in the first storage space to the second storage space, and the target virtual item being any virtual item in the first storage space; and
an item transfer module 1203, configured to: transfer the target virtual item from the first storage space to a first item storage area if the release position is located in the first item storage area, the first item storage area being an item storage area corresponding to a target storage container label in the multiple storage container labels, and the target storage container label being any one of the multiple storage container labels;
the item transfer module 1203 being further configured to: transfer at least one first-type virtual item in the first storage space to the first item storage area if the release position is on the target storage container label, the first-type virtual item being a virtual item having a same type as the target virtual item.

According to the apparatus provided in this embodiment of this application, when a drag operation from one storage space to another storage space is detected, based on different release positions of the drag operation, a single transfer operation for a currently selected virtual item and a batch transfer operation for all virtual items of the same type are separately provided. That is, when the release position is located in the item storage area, only the currently selected virtual item is transferred. When the release position is located on a storage container label, all the virtual items of the same type are transferred in batches, so that a user can control the release position of the drag operation, to flexibly control which virtual items need to be transferred in batches currently. In addition, batch transfer of items of the same type can be controlled by using only one drag operation. This prevents the user from manually repeatedly performing an item transfer operation for multiple times, thereby reducing operation cumbersomeness of the user, and improving item transfer efficiency and human-computer interaction efficiency.

In a possible implementation, the item transfer module 1203 is configured to:
determine, based on an item type of the target virtual item, the at least one first-type virtual item from the multiple virtual items stored in the first storage space; and
transfer all the at least one first-type virtual item to the first item storage area.

In a possible implementation, the item transfer module 1203 is configured to:
remove the at least one first-type virtual item from the first storage space; and
display the at least one first-type virtual item in the first item storage area.

In a possible implementation, based on the apparatus in FIG. 12, the apparatus further includes:
a name setting module, configured to: if the release position is located on the target storage container label, modify a label name of the target storage container label, so that the label name is consistent with an item name of the target virtual item.

In a possible implementation, based on the apparatus in FIG. 12, the apparatus further includes:
an icon setting module, configured to: if the release position is located on the target storage container label, modify a label icon of the target storage container label, so that the label icon is consistent with an item icon of the target virtual item.

In a possible implementation, based on the apparatus in FIG. 12, the apparatus further includes:
a type determining module, configured to: determine, in response to a second drag operation, a target item type associated with a first storage container label, the second drag operation being configured for dragging the first storage container label in the multiple storage container labels to the first storage space, and the first storage container label being any storage container label in the second storage space; and
the item transfer module 1203 is further configured to transfer at least one second-type virtual item in a second item storage area to the first storage space, the second item storage area being an item storage area corresponding to the first storage container label, and the second-type virtual item being a virtual item that has the target item type.

In a possible implementation, the type determining module is further configured to:
determine an item type of a virtual item associated with a label name of the first storage container label as the target item type; or
determine an item type of a virtual item associated with a label icon of the first storage container label as the target item type; or
determine an item type of a virtual item with a largest storage quantity in the item storage area corresponding to the first storage container label as the target item type.

In a possible implementation, the item transfer module 1203 is further configured to:
remove the at least one second-type virtual item from the second item storage area; and
display the at least one second-type virtual item in the first storage space.

In a possible implementation, based on the apparatus in FIG. 12, the apparatus further includes:
a restoration module, configured to restore a label name of the first storage container label to a preset name in response to the second drag operation; and
the restoration module is further configured to restore a label icon of the first storage container label to a preset icon in response to the second drag operation.

In a possible implementation, based on the apparatus in FIG. 12, the apparatus further includes:
a setting module, configured to: in response to the second drag operation, determine, when another virtual item is still stored in the second item storage area, a first virtual item with a largest storage quantity from the another virtual item; modify a label name of the first storage container label, so that the label name is consistent with an item name of the first virtual item; and modify a label icon of the first storage container label, so that the label icon is consistent with an item icon of the first virtual item.

All the foregoing technical solutions can be randomly combined to form exemplary embodiments of the present disclosure, and details are not described herein.

Division of the foregoing functional modules is only described for exemplary purposes when the apparatus for transferring a virtual item provided in the foregoing embodiments transfers virtual items in batches. In an actual application, the foregoing functions may be allocated to be accomplished by different functional modules according to requirements, that is, the internal structure of the electronic device is divided into different functional modules, to accomplish all or some functions of the above described functions. In addition, the apparatus for transferring a virtual item provided in the foregoing embodiments and the embodiments of the method for transferring a virtual item belong to the same concept. For a specific implementation process, refer to the method embodiments, and details are not described herein again.

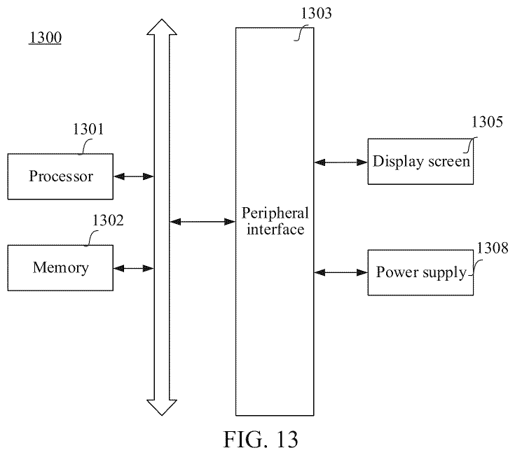

FIG. 13 is a schematic structural diagram of a terminal according to an embodiment of this application. As shown in FIG. 13, a terminal 1300 is an example description of an electronic device. Generally, the terminal 1300 includes: a processor 1301 and a memory 1302.

In some embodiments, the processor 1301 includes one or more processing cores, for example, a 4-core processor or an 8-core processor. In some embodiments, the processor 1301 is implemented in at least one hardware form of a digital signal processor (DSP), a field-programmable gate array (FPGA), and a programmable logic array (PLA). In some embodiments, the processor 1301 includes a main processor and a coprocessor. The main processor is configured to process data in an active state, also referred to as a central processing unit (CPU). The coprocessor is a low-power processor configured to process data in a standby state. In some embodiments, the processor 1301 may be integrated with a graphics processing unit (GPU). The GPU is configured to render and draw content that needs to be displayed on a display screen. In some embodiments, the processor 1301 may further include an artificial intelligence (AI) processor. The AI processor is configured to process computing operations related to machine learning.

In some embodiments, the memory 1302 includes one or more computer-readable storage media, and in some embodiments, the computer readable storage medium is non-transitory. In some embodiments, the memory 1302 may include a high-speed random access memory (RAM) and a nonvolatile memory, for example, one or more disk storage devices or flash storage devices. In some embodiments, a non-transient computer readable storage medium in the memory 1302 is configured to store at least one computer program, and the at least one computer program is used by the processor 1301 to implement the method for transferring a virtual item provided in the embodiments of this application.

In some embodiments, the terminal 1300 further includes: a peripheral device interface 1303 and at least one peripheral device. The processor 1301, the memory 1302, and the peripheral device interface 1303 can be connected by using a bus or a signal cable. Each peripheral device can be connected to the peripheral device interface 1303 by using a bus, a signal cable, or a circuit board. Specifically, the peripheral device includes: at least one of a display screen 1305 and a power supply 1308.

The display screen 1305 is configured to display a user interface (UI). In some embodiments, the UI includes a graph, a text, an icon, a video, and any combination thereof. When the display screen 1305 is a touchscreen, the display screen 1305 is further capable of obtaining a touch signal on or above a surface of the display screen 1305. The touch signal can be used as a control signal to be inputted to the processor 1301 for processing. In some embodiments, in this case, the display screen 1305 may be further configured to provide a virtual button and/or a virtual keyboard that are/is also referred to as a soft button and/or a soft keyboard. In some embodiments, there is one display screen 1305 disposed on a front panel of the terminal 1300. In some other embodiments, there are at least two display screens 1305 that are respectively disposed on different surfaces of the terminal 1300 or folded. In still other embodiments, the display screen 1305 is a flexible display screen disposed on a curved surface or a folded surface of the terminal 1300. Even, in some embodiments, the display screen 1305 is disposed in a non-rectangular irregular pattern, namely, a special-shaped screen. In some embodiments, the display screen 1305 is prepared by using materials such as a liquid crystal display (LCD), an organic light-emitting diode (OLED), or the like.

The power supply 1308 is configured to supply power to components in the terminal 1300. In some embodiments, the power supply 1308 is an alternating-current power supply, a direct-current power supply, a disposable battery, or a rechargeable battery. When the power supply 1308 includes the rechargeable battery, the rechargeable battery may support wired charging or wireless charging. The rechargeable battery is further configured to support a fast charging technology.

A person skilled in the art can understand that the structure shown in FIG. 13 does not constitute a limitation on the terminal 1300, and can include more or fewer components than those shown in the figure, or combine some components, or use different component arrangements.

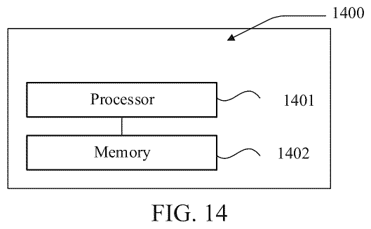

FIG. 14 is a schematic structural diagram of an electronic device according to an embodiment of this application. An electronic device 1400 may vary greatly according to configuration or performance. The electronic device 1400 includes one or more central processing units (CPU) 1401 and one or more memories 1402. The memory 1402 stores at least one computer program, and the at least one computer program is loaded and executed by the one or more processors 1401 to implement the method for transferring a virtual item provided in the foregoing embodiments. In some embodiments, the electronic device 1400 further includes components such as a wired or wireless network interface, a keyboard, and an input/output interface, to facilitate input and output. The electronic device 1400 further includes another component configured to implement a function of a device. Details are not further described herein.

In an example embodiment, a non-transitory computer-readable storage medium is further provided, for example, a memory including at least one computer program. The at least one computer program may be executed by a processor in a terminal to complete the method for transferring a virtual item in the foregoing embodiments. For example, the computer readable storage medium includes a read-only memory (ROM), a random access memory (RAM), a compact disc read-only memory (CD-ROM), a magnetic tape, a floppy disk, and an optical data storage device.

In an example embodiment, a computer program product is further provided, including one or more computer programs stored in a computer readable storage medium. One or more processors of an electronic device can read the one or more computer programs from the computer readable storage medium, and the one or more processors execute the one or more computer programs, so that the electronic device can perform the method for transferring a virtual item in the foregoing embodiments.

A person of ordinary skill in the art can understand that all or some of the operations of the embodiments may be implemented by hardware or a program instructing relevant hardware. In some embodiments, the program is stored in a computer readable storage medium. In some embodiments, the storage medium mentioned above is a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for transferring a virtual item performed by an electronic device, the method comprising:
displaying a first storage space and a second storage space, the first storage space including multiple virtual items, the second storage space including multiple storage container labels, and each storage container label corresponding to one item storage area;
detecting a first drag operation of dragging a target virtual item from the first storage space to the second storage space;
in response to the first drag operation, determining a release position of a first drag operation;
when the release position is located in a first item storage area, transferring the target virtual item from the first storage space to the first item storage area, the first item storage area being an item storage area corresponding to a target storage container label in the multiple storage container labels; and
when the release position is on the target storage container label, transferring at least one first-type virtual item in the first storage space to the first item storage area, the first-type virtual item being a virtual item having a same type as the target virtual item.

2. The method according to claim 1, wherein the transferring at least one first-type virtual item in the first storage space to the first item storage area comprises:
determining, based on an item type of the target virtual item, the at least one first-type virtual item from the multiple virtual items stored in the first storage space; and
transferring all the at least one first-type virtual item to the first item storage area.

3. The method according to claim 1, wherein the transferring at least one first-type virtual item in the first storage space to the first item storage area comprises:
removing the at least one first-type virtual item from the first storage space; and
displaying the at least one first-type virtual item in the first item storage area.

4. The method according to claim 1, wherein the method further comprises:
when the release position is on the target storage container label, modifying a label name of the target storage container label, so that the label name is consistent with an item name of the target virtual item.

5. The method according to claim 1, wherein the method further comprises:
when the release position is on the target storage container label, modifying a label icon of the target storage container label, so that the label icon is consistent with an item icon of the target virtual item.

6. The method according to claim 1, wherein the method further comprises:
determining, in response to a second drag operation, a target item type associated with a first storage container label, the second drag operation being configured for dragging the first storage container label in the multiple storage container labels to the first storage space, and the first storage container label being any storage container label in the second storage space; and
transferring at least one second-type virtual item in a second item storage area to the first storage space, the second item storage area being an item storage area corresponding to the first storage container label, and the second-type virtual item being a virtual item that has the target item type.

7. The method according to claim 6, wherein the determining a target item type associated with a first storage container label comprises:
determining an item type of a virtual item associated with a label name of the first storage container label as the target item type; or
determining an item type of a virtual item associated with a label icon of the first storage container label as the target item type; or
determining an item type of a virtual item with a largest storage quantity in the item storage area corresponding to the first storage container label as the target item type.

8. An electronic device comprising one or more processors and one or more memories, the one or more memories storing at least one computer program, and the at least one computer program, when executed by the one or more processors, causing the electronic device to perform a method for transferring a virtual item including:
displaying a first storage space and a second storage space, the first storage space including multiple virtual items, the second storage space including multiple storage container labels, and each storage container label corresponding to one item storage area;
detecting a first drag operation of dragging a target virtual item from the first storage space to the second storage space;
in response to the first drag operation, determining a release position of a first drag operation;
when the release position is located in a first item storage area, transferring the target virtual item from the first storage space to the first item storage area, the first item storage area being an item storage area corresponding to a target storage container label in the multiple storage container labels; and
when the release position is on the target storage container label, transferring at least one first-type virtual item in the first storage space to the first item storage area, the first-type virtual item being a virtual item having a same type as the target virtual item.

9. The electronic device according to claim 8, wherein the transferring at least one first-type virtual item in the first storage space to the first item storage area comprises:
determining, based on an item type of the target virtual item, the at least one first-type virtual item from the multiple virtual items stored in the first storage space; and
transferring all the at least one first-type virtual item to the first item storage area.

10. The electronic device according to claim 8, wherein the transferring at least one first-type virtual item in the first storage space to the first item storage area comprises:
removing the at least one first-type virtual item from the first storage space; and
displaying the at least one first-type virtual item in the first item storage area.

11. The electronic device according to claim 8, wherein the method further comprises:
when the release position is on the target storage container label, modifying a label name of the target storage container label, so that the label name is consistent with an item name of the target virtual item.

12. The electronic device according to claim 8, wherein the method further comprises:
when the release position is on the target storage container label, modifying a label icon of the target storage container label, so that the label icon is consistent with an item icon of the target virtual item.

13. The electronic device according to claim 8, wherein the method further comprises:
determining, in response to a second drag operation, a target item type associated with a first storage container label, the second drag operation being configured for dragging the first storage container label in the multiple storage container labels to the first storage space, and the first storage container label being any storage container label in the second storage space; and
transferring at least one second-type virtual item in a second item storage area to the first storage space, the second item storage area being an item storage area corresponding to the first storage container label, and the second-type virtual item being a virtual item that has the target item type.

14. The electronic device according to claim 13, wherein the determining a target item type associated with a first storage container label comprises:
determining an item type of a virtual item associated with a label name of the first storage container label as the target item type; or
determining an item type of a virtual item associated with a label icon of the first storage container label as the target item type; or
determining an item type of a virtual item with a largest storage quantity in the item storage area corresponding to the first storage container label as the target item type.

15. A non-transitory computer-readable storage medium storing at least one computer program, and the at least one computer program, when executed by a processor of an electronic device, causing the electronic device to perform a method for transferring a virtual item including:
displaying a first storage space and a second storage space, the first storage space including multiple virtual items, the second storage space including multiple storage container labels, and each storage container label corresponding to one item storage area;
detecting a first drag operation of dragging a target virtual item from the first storage space to the second storage space;
in response to the first drag operation, determining a release position of a first drag operation;
when the release position is located in a first item storage area, transferring the target virtual item from the first storage space to the first item storage area, the first item storage area being an item storage area corresponding to a target storage container label in the multiple storage container labels; and
when the release position is on the target storage container label, transferring at least one first-type virtual item in the first storage space to the first item storage area, the first-type virtual item being a virtual item having a same type as the target virtual item.

16. The non-transitory computer-readable storage medium according to claim 15, wherein the transferring at least one first-type virtual item in the first storage space to the first item storage area comprises:
determining, based on an item type of the target virtual item, the at least one first-type virtual item from the multiple virtual items stored in the first storage space; and
transferring all the at least one first-type virtual item to the first item storage area.

17. The non-transitory computer-readable storage medium according to claim 15, wherein the transferring at least one first-type virtual item in the first storage space to the first item storage area comprises:
removing the at least one first-type virtual item from the first storage space; and
displaying the at least one first-type virtual item in the first item storage area.

18. The non-transitory computer-readable storage medium according to claim 15, wherein the method further comprises:
when the release position is on the target storage container label, modifying a label name of the target storage container label, so that the label name is consistent with an item name of the target virtual item.

19. The non-transitory computer-readable storage medium according to claim 15, wherein the method further comprises:
when the release position is on the target storage container label, modifying a label icon of the target storage container label, so that the label icon is consistent with an item icon of the target virtual item.

20. The non-transitory computer-readable storage medium according to claim 15, wherein the method further comprises:
determining, in response to a second drag operation, a target item type associated with a first storage container label, the second drag operation being configured for dragging the first storage container label in the multiple storage container labels to the first storage space, and the first storage container label being any storage container label in the second storage space; and
transferring at least one second-type virtual item in a second item storage area to the first storage space, the second item storage area being an item storage area corresponding to the first storage container label, and the second-type virtual item being a virtual item that has the target item type.
